(19) United States
(12) Patent Application Publication
(10) Pub. No.: US 2024/0154760 A1
(43) Pub. Date: May 9, 2024

(54) METHOD AND APPARATUS FOR MULTIPLEXING CSI FOR MULTI-TRP COHERENT JOINT TRANSMISSION

(71) Applicant: Samsung Electronics Co., Ltd., Suwon-si (KR)

(72) Inventors: Gilwon Lee, McKinney, TX (US); Md. Saifur Rahman, Plano, TX (US); Eko Onggosanusi, Coppell, TX (US)

(21) Appl. No.: 18/479,771

(22) Filed: Oct. 2, 2023

Related U.S. Application Data
(60) Provisional application No. 63/416,239, filed on Oct. 14, 2022.
(60) Provisional application No. 63/447,831, filed on Feb. 23, 2023.

(51) Int. Cl. H04L 5/00

(52) U.S. Cl. CPC H04L 5/0051; H04L 5/0035

(57) ABSTRACT

Methods and apparatuses for multiplexing channel status information (CSI) for a multi-transmission reception point (TRP) coherent joint transmission in a wireless communication system a method performed by a UE is provided. The method includes receiving information about a CSI report associated with Nₜᵣₚ≥1 CSI reference signal (CSI-RS) resources, where the CSI report includes a CSI Part 1 and a CSI Part 2 and, based on the information, determining the CSI Part 2 including groups G1 or G2. An amplitude coefficient indicator and a phase coefficient indicator are included in G1 or G2 based on a priority value Pri(l, i, f, r)=2·Σₙ₌₁^{N}L_{ϕ(n)}·v·π(f)+2·v·Σₙ₌₁^{r-1}L_{ϕ(n)}+v·i+l The method further includes transmitting the CSI Part 1 and the determined CSI Part 2.

### CROSS-REFERENCE TO RELATED APPLICATIONS AND CLAIM OF PRIORITY

The present application claims priority to U.S. Provisional Patent Application No. 63/416,239, filed on Oct. 14, 2022, and U.S. Provisional Patent Application No. 63/447,831, filed on Feb. 23, 2023. The contents of the above-identified patent documents are incorporated herein by reference.

### TECHNICAL FIELD

The present disclosure relates generally to wireless communication systems and, more specifically, the present disclosure relates to multiplexing channel status information (CSI) for a multi-transmission reception point (TRP) coherent joint transmission in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to multiplexing CSI for a multi-TRP coherent joint transmission in a wireless communication system.

In one embodiment, a user equipment (UE) is provided. The UE includes a transceiver configured to receive information about a channel state information (CSI) report associated with Nₜᵣₚ≥1 CSI reference signal (CSI-RS) resources where the CSI report includes a CSI Part 1 and a CSI Part 2. The UE further includes a processor operably coupled to the transceiver. The processor, based on the information, is configured to determine the CSI Part 2 including groups G1 or G2. An amplitude coefficient indicator and a phase coefficient indicator are included in G1 or G2 based on a priority value Pri(l,i,f,r)=2·Σₙ₌₁^{N}L_{ϕ(n)}·v·π(f)+2·v·Σₙ₌₁^{r-1}L_{ϕ(n)}+v·i+l . Here, π(f) is a permutation function, Lᵣ is a number of spatial-domain (SD) basis vectors associated with CSI-RS resource r, ϕ(n) is a function to map an index n∈{1, . . . , N} to a CSI-RS resource index r∈{1, . . . , Nₜᵣₚ}, v is a number of layers, l=1,2, . . . , v, i=0,1, . . . ,2Lᵣ−1, f=0,1, . . . , Mᵥ−1, Mᵥ is a number of frequency-domain (FD) basis vectors, and 1≤N≤Nₜᵣₚ. The transceiver is further configured to transmit the CSI Part 1 and the determined CSI Part 2.

In another embodiment, a base station (BS) is provided. The BS includes a transceiver configured to transmit information about a CSI report associated with Nₜᵣₚ≥1 CSI reference signal (CSI-RS) resources, where the CSI report includes a CSI Part 1 and a CSI Part 2 and receive the CSI Part 1 and the CSI Part 2. The CSI Part 2 includes groups G1 or G2. An amplitude coefficient indicator and a phase coefficient indicator are included in G1 or G2 based on a priority valuePri(l,i,f,r)=2·Σₙ₌₁^{N}L_{ϕ(n)}·v·π(f)+2·v·Σₙ₌₁^{r-1}L_{ϕ(n)}+v·i+l.

In yet another embodiment, a method performed by a UE is provided. The method includes receiving information about a CSI report associated with Nₜᵣₚ≥1 CSI-RS resources, where the CSI report includes a CSI Part 1 and a CSI Part 2 and, based on the information, determining the CSI Part 2 including groups G1 or G2. An amplitude coefficient indicator and a phase coefficient indicator are included in G1 or G2 based on a priority value Pri(l,i,f,r)=2·Σₙ₌₁^{N}L_{ϕ(n)}·v·π(f)+2·v·Σₙ₌₁^{r-1}L_{ϕ(n)}+v·i+l The method further includes transmitting the CSI Part 1 and the determined CSI Part 2.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates an example of antenna structure according to embodiments of the present disclosure;

FIGS. 7 and 8 illustrate examples of distributed MIMO according to embodiments of the present disclosure;

FIG. 9 illustrates an example of antenna port layout according to embodiments of the present disclosure;

FIG. 10 illustrates an example of 3D grid of DFT vectors according to embodiments of the present disclosure;

FIG. 11 illustrates an example of codebook according to embodiments of the present disclosure;

FIG. 12 illustrates an example of UCI used to multiplex and report CSI according to embodiments of the present disclosure; and

FIG. 13 illustrates an example flowchart for a process performed by a UE according to embodiments of the present disclosure.

### DETAILED DESCRIPTION

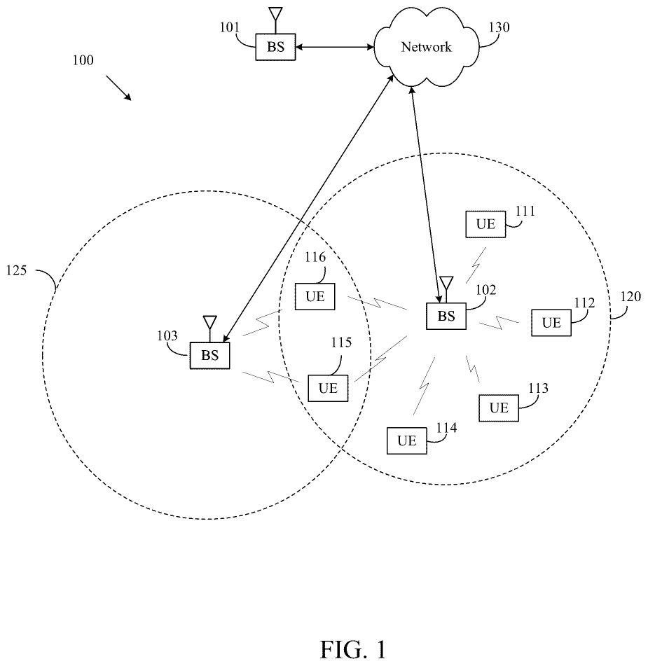

FIG. 1 through FIG. 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 36.211 v17.2.0, “E-UTRA, Physical channels and modulation”; 3GPP TS 36.212 v17.2.0, “E-UTRA, Multiplexing and Channel coding”; 3GPP TS 36.213 v17.2.0, “E-UTRA, Physical Layer Procedures”; 3GPP TS 36.321 v17.1.0, “E-UTRA, Medium Access Control (MAC) protocol specification”; 3GPP TS 36.331 v17.1.0, “E-UTRA, Radio Resource Control (RRC) Protocol Specification”; 3GPP TS 38.211 v17.2.0, “NR, Physical channels and modulation”; 3GPP TS 38.212 v17.2.0, “NR, Multiplexing and Channel coding”; 3GPP TS 38.213 v17.2.0, “NR, Physical Layer Procedures for Control”; 3GPP TS 38.214 v17.2.0, “NR, Physical Layer Procedures for Data”; 3GPP TS 38.215 v17.1.0, “NR, Physical Layer Measurements”; 3GPP TS 38.321 v17.1.0, “NR, Medium Access Control (MAC) protocol specification”; and 3GPP TS 38.331 v17.1.0, “NR, Radio Resource Control (RRC) Protocol Specification.”

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for multiplexing CSI for a multi-TRP coherent joint transmission in a wireless communication system. In certain embodiments, and one or more of the gNBs 101-103 includes circuitry, programing, or a combination thereof, to support multiplexing CSI for a multi-TRP coherent joint transmission in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

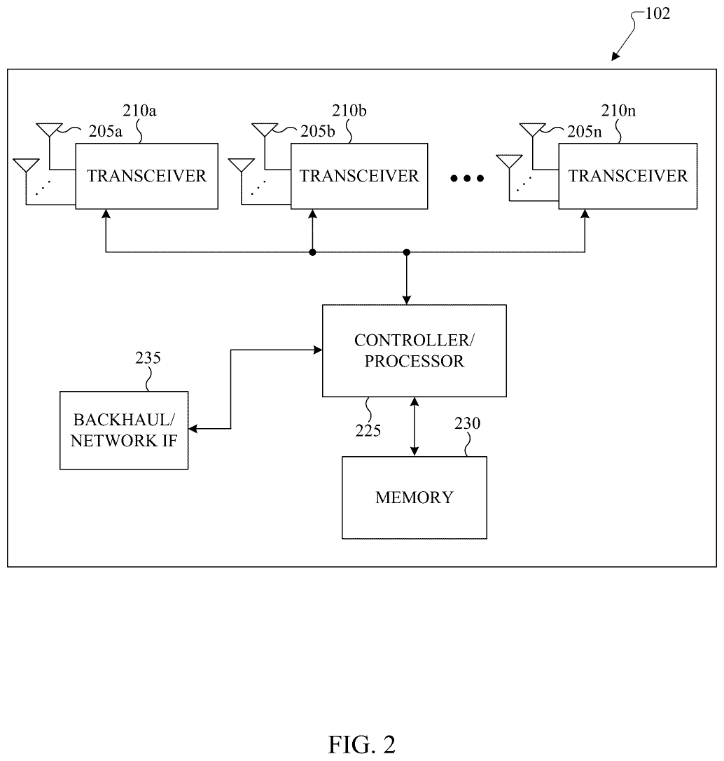

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes to support multiplexing of CSI for a multi-TRP coherent joint transmission in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

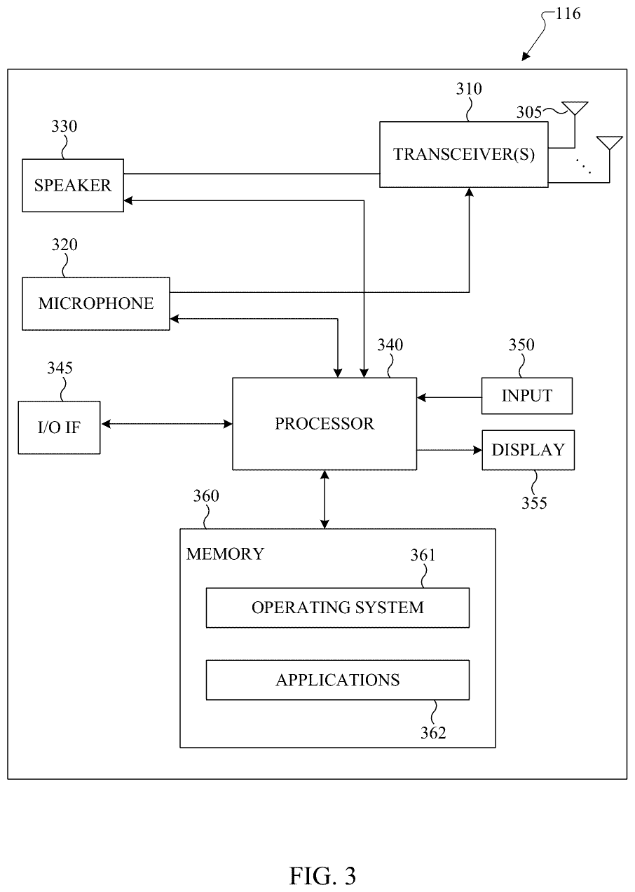

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for multiplexing CSI for a multi-TRP coherent joint transmission in a wireless communication system.

The processor 340 can move data into or out of the memory 360 as required by an executing process. In some embodiments, the processor 340 is configured to execute the applications 362 based on the OS 361 or in response to signals received from gNB s or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

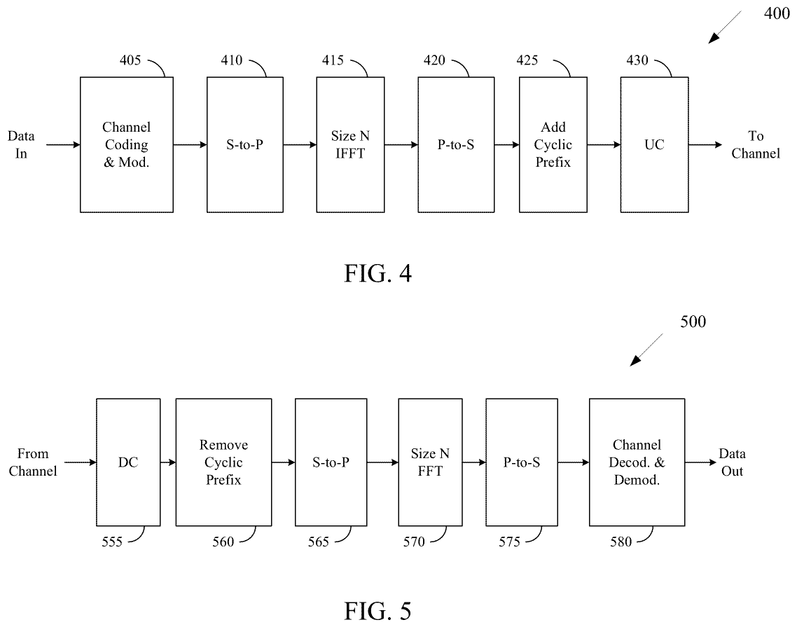

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the transmit path 400 is configured to support for multiplexing CSI for a multi-TRP coherent joint transmission in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an

FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNB s 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIGS. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a TCI state of a CORESET where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process consists of NZP CSI-RS and CSI-IM resources. A UE can determine CSI-RS transmission parameters through DL control signaling or higher layer signaling, such as an RRC signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a MIMO transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

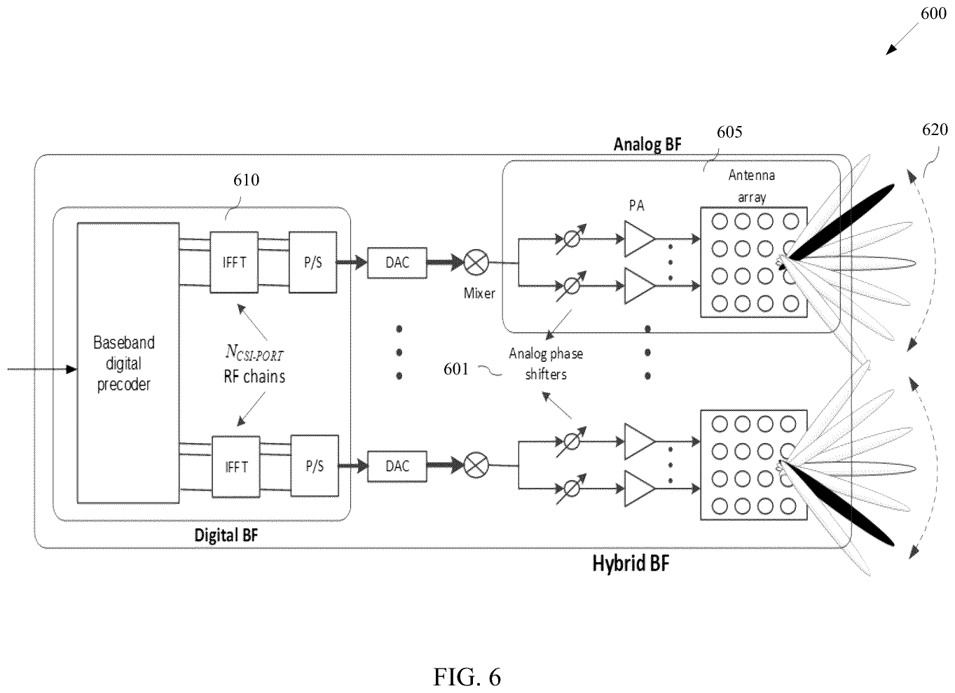

Re1.14 LTE and Re1.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 6.

FIG. 6 illustrates an example antenna structure 600 according to embodiments of the present disclosure. An embodiment of the antenna structure 600 shown in FIG. 6 is for illustration only.

In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting,” respectively), and receiving a DL or UL transmission via a selection of a corresponding RX beam.

The aforementioned system is also applicable to higher frequency bands such as >52.6GHz. In this case, the system can employ only analog beams. Due to the O2 absorption loss around 60GHz frequency (−10dB additional loss @100m distance), larger number of and sharper analog beams (hence larger number of radiators in the array) may be needed to compensate for the additional path loss.

For a cellular system operation in a sub-1GHz frequency range (e.g., less than 1 GHz), supporting large number of CSI-RS antenna ports (e.g., 32) at a single location or remote radio head (RRH) or TRP is challenging due to that a larger antenna form factor size is needed at these frequencies than a system operating at a higher frequency such as 2 GHz or 4 GHz. At such low frequencies, the maximum number of CSI-RS antenna ports that can be co-located at a single site (or TRP/RRH) can be limited, for example to 8. This limits the spectral efficiency of such systems. In particular, the MU-MIMO spatial multiplexing gains offered due to large number of CSI-RS antenna ports (such as 32) cannot be achieved.

One way to operate a sub-1GHz system with large number of CSI-RS antenna ports is based on distributing antenna ports at multiple locations (or TRP/RRHs). The multiple sites or TRPs/RRHs can still be connected to a single (common) base unit, hence the signal transmitted/received via multiple distributed TRPs/RRHs can still be processed at a centralized location. This is called distributed MIMO or multi-TRP coherent joint transmission (C-JT).

The present disclosure provides two-part CSI or UCI framework for multi-TRP C-JT scenarios and proposes method and apparatus for grouping for Part 1 and Part 2 CSI reporting in multi-TRP scenarios.

The present disclosure relates to electronic devices and methods on CSI reporting for MIMO operations, more particularly, to electronic devices and methods on two-part UCI for distributed MIMO or multi-TRP operations in wireless networks.

CSI enhancement described in Rel-18 MIMO considers Rel-16/17 Type-II CSI codebook refinements to support mTRP coherent joint transmission (C-JT) operations by considering performance-and-overhead trade-off. The Rel-16/17 Type-II CSI codebook has three components W₁, W₂, and W_{f}, and the Rel-18 Type-II CSI codebook for CJT has been developing based on the Rel-16/17 Type-II CSI codebooks, which is associated with multiple CSI-RS resources (multiple TRPs). Therefore, CSI includes elements associated with multiple TRPs (or CSI-RS resources), and thus the legacy framework of two-part CSI or two-part UCI needs to be enhanced for further efficient CSI reporting to be tailored for Rel-18 Type-II CSI framework.

In the present disclosure, components to partition groups for designing two-part CSI or two-part UCI are provided for multi-TRP C-JT scenarios.

Although the focus of the present disclosure is on 3GPP 5G NR communication systems, various embodiments may apply in general to UEs operating with other RATs and/or standards, such as different releases/generations of 3GPP standards (including beyond 5G, 6G, and so on), IEEE standards (such as 802.16 WiMAX and 802.11 Wi-Fi), and so on.

Re1.14 LTE and Re1.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 6.

At lower frequency bands such as <1GHz, on the other hand, the number of antenna elements may not be large in a given form factor due to the large wavelength. As an example, for the case of the wavelength size (A) of the center frequency 600 MHz (which is 50 cm), it desires 4 m for uniform-linear-array (ULA) antenna panel of 16 antenna elements with the half-wavelength distance between two adjacent antenna elements. Considering a plurality of antenna elements is mapped to one digital port in practical cases, the desirable size for antenna panel(s) at gNB to support a large number of antenna ports such as 32 CSI-RS ports becomes very large in such low frequency bands, and it leads the difficulty of deploying 2-D antenna element arrays within the size of a conventional form factor. This results in a limited number of CSI-RS ports that can be supported at a single site and limits the spectral efficiency of such systems.

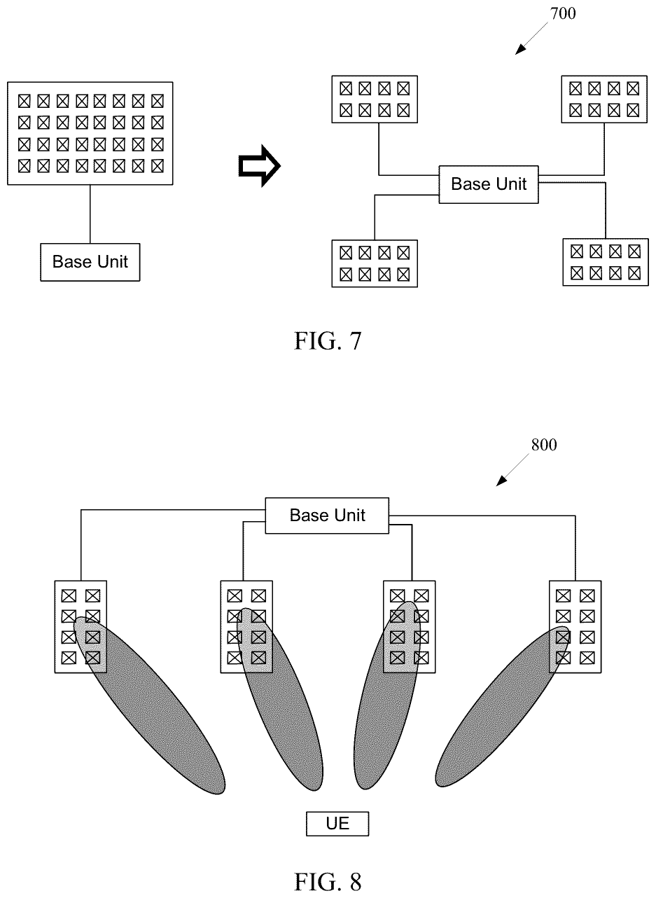

One possible approach to resolving the issue is to form multiple TRPs (multi-TRP) or RRHs with a small number of antenna ports instead of integrating all of the antenna ports in a single panel (or at a single site) and to distribute the multiple panels in multiple locations/sites (or TRPs, RRHs). This approach, concept of distributed MIMO (D-MIMO), is shown in FIG. 7.

FIGS. 7 and 8 illustrate examples of distributed MIMO 700 and 800 according to embodiments of the present disclosure. An embodiment of the distributed MIMO 700 and 800 shown in FIG. 8 are for illustration only.

The multiple TRPs at multiple locations can still be connected to a single base unit, and thus the signal transmitted/received via multiple distributed TRPs can be processed in a centralized manner through the single base unit, as illustrated in FIG. 8.

Note that although low frequency band systems (sub-1GHz band) is provided as a motivation for distributed MIMO (or mTRP), the distributed MIMO technology is frequency-band-agnostic and can be useful in mid- (sub-6GHz) and high-band (above-6GHz) systems in addition to low-band (sub-1GHz) systems.

The terminology “distributed MIMO” is used as an illustrative purpose, it can be considered under another terminology such as multi-TRP, mTRP, cell-free network, and so on.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, all the following components and embodiments are applicable for UL transmission when the scheduling unit in time is either one subframe (which can consist of one or multiple slots) or one slot.

In the present disclosure, the frequency resolution (reporting granularity) and span (reporting bandwidth) of CSI reporting can be defined in terms of frequency “subbands” and “CSI reporting band” (CRB), respectively.

A subband for CSI reporting is defined as a set of contiguous PRBs which represents the smallest frequency unit for CSI reporting. The number of PRBs in a subband can be fixed for a given value of DL system bandwidth, configured either semi-statically via higher-layer/RRC signaling, or dynamically via Li DL control signaling or MAC control element (MAC CE). The number of PRBs in a subband can be included in CSI reporting setting.

A “CSI reporting band” is defined as a set/collection of subbands, either contiguous or non-contiguous, wherein CSI reporting is performed. For example, CSI reporting band can include all the subbands within the DL system bandwidth. This can also be termed “full-band.” Alternatively, CSI reporting band can include only a collection of subbands within the DL system bandwidth. This can also be termed “partial band.”

The term “CSI reporting band” is used only as an example for representing a function. Other terms such as “CSI reporting subband set” or “CSI reporting bandwidth” or bandwidth part (BWP) can also be used.

In terms of UE configuration, a UE can be configured with at least one CSI reporting band. This configuration can be semi-static (via higher-layer signaling or RRC) or dynamic (via MAC CE or Ll DL control signaling). When configured with multiple (N) CSI reporting bands (e.g., via RRC signaling), a UE can report CSI associated with n≤N CSI reporting bands. For instance, >6GHz, large system bandwidth may desire multiple CSI reporting bands. The value of n can either be configured semi-statically (via higher-layer signaling or RRC) or dynamically (via MAC CE or Ll DL control signaling). Alternatively, the UE can report a recommended value of n via an UL channel.

Therefore, a CSI parameter frequency granularity can be defined per CSI reporting band as follows. A CSI parameter is configured with “single” reporting for the CSI reporting band with M n subbands when one CSI parameter for all the M n subbands within the CSI reporting band. A CSI parameter is configured with “subband” for the CSI reporting band with M n subbands when one CSI parameter is reported for each of the M n subbands within the CSI reporting band.

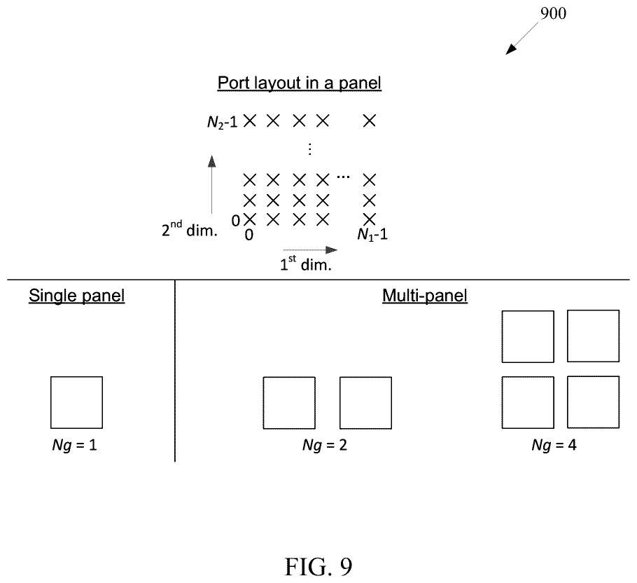

FIG. 9 illustrates an example of antenna port layout 900 according to embodiments of the present disclosure. An embodiment of the antenna port layout 900 shown in FIG. 9 is for illustration only.

In the following, it may assume that N₁ and N₂ are the number of antenna ports with the same polarization in the first and second dimensions, respectively. For 2D antenna port layouts, there may be N₁>1, N₂>1, and for 1D antenna port layouts N₁>1 and N₂=1. So, for a dual-polarized antenna port layout, the total number of antenna ports is 2N₁N₂ when each antenna maps to an antenna port. An illustration is shown in FIG. 9 where “X” represents two antenna polarizations. In this disclosure, the term “polarization” refers to a group of antenna ports. For example, antenna ports

$$j = X + 0 , X + 1 , … , X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 , … , X + {P}_{CSIRS} - 1$$

comprise a second antenna polarization, where P_{CSIRS} is a number of CSI-RS antenna ports and X is a starting antenna port number (e.g., X=3000, then antenna ports are 3000, 3001, 3002, . . . ). Let N_{g} be a number of antenna panels at the gNB. When there are multiple antenna panels (N_{g}>1), it may assume that each panel is dual-polarized antenna ports with N₁ and N₂ ports in two dimensions. This is illustrated in FIG. 9 Note that the antenna port layouts may or may not be the same in different antenna panels.

In one example, the antenna architecture of a D-MIMO or CJT (coherent joint-transmission) system is structured. For example, the antenna structure at each RRH (or TRP) is dual-polarized (single or multi-panel as shown in FIG. 9. The antenna structure at each RRH/TRP can be the same. Or the antenna structure at an RRH/TRP can be different from another RRH/TRP. Likewise, the number of ports at each RRH/TRP can be the same. Or the number of ports at one RRH/TRP can be different from another RRH/TRP. In one example, N_{g}=N_{RRH}, a number of RRHs/TRPs in the D-MIMO transmission.

In another example, the antenna architecture of a D-MIMO or CJT system is unstructured. For example, the antenna structure at one RRH/TRP can be different from another RRH/TRP.

It may assume a structured antenna architecture in the rest of the disclosure. For simplicity, it may assume each RRH/TRP is equivalent to a panel (cf. FIG. 9), although, an RRH/TRP can have multiple panels in practice. The disclosure however is not restrictive to a single panel assumption at each RRH/TRP, and can easily be extended (covers) the case when an RRH/TRP has multiple antenna panels.

In one embodiment, an RRH constitutes (or corresponds to or is equivalent to or is associated with) at least one of the following examples.

In one example, an RRH corresponds to a TRP.

In one example, an RRH or TRP corresponds to a CSI-RS resource. A UE is configured with K=N_{RRH}=(N_{TRP})>1 non-zero-power (NZP) CSI-RS resources, and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained earlier in this disclosure.

In one example, an RRH or TRP corresponds to a CSI-RS resource group, where a group comprises one or multiple NZP CSI-RS resources. A UE is configured with K≥N_{RRH}>1 non-zero-power (NZP) CSI-RS resources, and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained earlier in this disclosure. In particular, the K CSI-RS resources can be partitioned into N RRH resource groups. The information about the resource grouping can be provided together with the CSI-RS resource setting/configuration, or with the CSI reporting setting/configuration, or with the CSI-RS resource configuration.

In one example, an RRH or TRP corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) an RRH/TRP. The information about the subsets of ports or grouping of ports can be provided together with the CSI-RS resource setting/configuration, or with the CSI reporting setting/configuration, or with the CSI-RS resource configuration.

In one example, an RRH or TRP corresponds to examples disclosed in the present disclosure depending on a configuration. For example, this configuration can be explicit via a parameter (e.g., an RRC parameter). Or the configuration can be implicit.

In one example, when implicit, it could be based on the value of K. For example, when K>1 CSI-RS resources, an RRH corresponds to example provided in the present disclosure, and when K=1 CSI-RS resource, an RRH corresponds to example provided in the present disclosure.

In another example, the configuration could be based on the configured codebook. For example, an RRH corresponds to a CSI-RS resource (e.g., example provided in the present disclosure) or resource group (e.g., examples as provided in the present disclosure) when the codebook corresponds to a decoupled codebook (modular or separate codebook for each RRH), and an RRH corresponds to a subset (or a group) of CSI-RS ports (e.g., example as provided in the present disclosure) when codebook corresponds to a coupled (joint or coherent) codebook (one joint codebook across TRPs/RRHs).

In one example, when RRH or TRP maps (or corresponds to) a CSI-RS resource or resource group (e.g., example as provided in the present disclosure), and a UE can select a subset of TRPs/RRHs (resources or resource groups) and report the CSI for the selected TRPs/RRHs (resources or resource groups), the selected TRPs/RRHs can be reported via an indicator. For example, the indicator can be a CRI or a PMI (component) or a new indicator.

In one example, when RRH or TRP maps (or corresponds to) a CSI-RS port group (e.g., example as provided in the present disclosure), and a UE can select a subset of TRPs/RRHs (port groups) and report the CSI for the selected TRPs/RRHs (port groups), the selected TRPs/RRHs can be reported via an indicator. For example, the indicator can be a CRI or a PMI (component) or a new indicator.

In one example, when multiple (K>1) CSI-RS resources are configured for N RRH TRPs/RRHs (e.g., examples as provided in the present disclosure), a decoupled (modular) codebook is used/configured, and when a single (K=1) CSI-RS resource for N RRH TRPs/RRHs (e.g., examples as provided in the present disclosure), a joint codebook is used/configured.

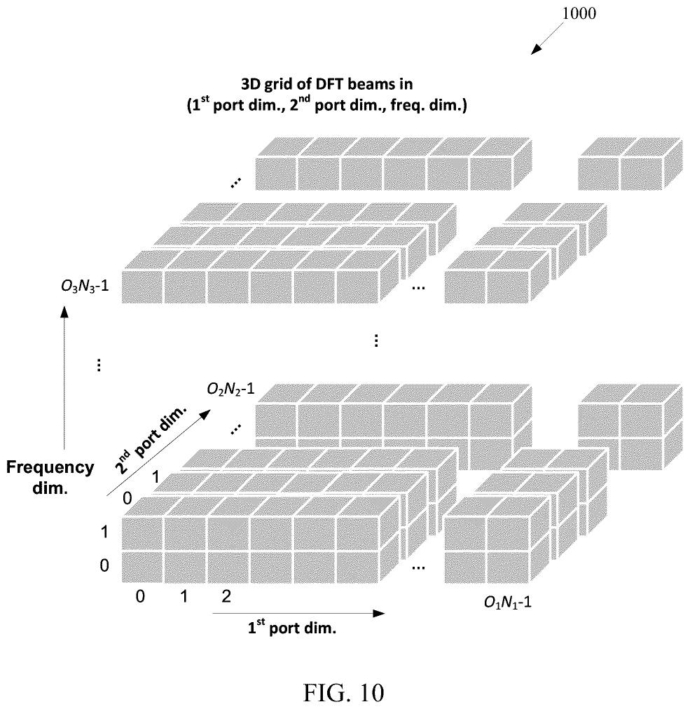

As described in U.S. Pat. No. 10,659,118, which is incorporated herein by reference in its entirety, a UE is configured with high-resolution (e.g., Type II) CSI reporting in which the linear combination based Type II CSI reporting framework is extended to include frequency dimension in addition to the 1st and 2nd antenna port dimensions. An illustration of the 3D grid of the oversampled DFT vectors (1st port dim., 2nd port dim., freq. dim.) is shown in FIG. 10 in which: (1) 1st dimension is associated with the 1st port dimension, (2) 2nd dimension is associated with the 2nd port dimension, and (3) 3rd dimension is associated with the frequency dimension.

FIG. 10 illustrates an example of 3D grid of DFT vectors 1000 according to embodiments of the present disclosure. An embodiment of the 3D grid of DFT vectors 1000 shown in FIG. 10 is for illustration only.

The basis sets for 1^{st} and 2^{nd} port domain representation are oversampled DFT codebooks of length-N₁ and length-N₂, respectively, and with oversampling factors O₁ and O₂, respectively. Likewise, the basis set for frequency domain representation (i.e., 3rd dimension) is an oversampled DFT codebook of length-N₃ and with oversampling factor O₃ . In one example, O₁=O₂=O₃=4. In one example, O₁=O₂=4 and O₃=1. In another example, the oversampling factors O₁ belongs to {2, 4, 8}. In yet another example, at least one of O₁, O₂, and O₃ is higher layer configured (via RRC signaling).

As explained in 3GPP standard specification TS38.213, a UE is configured with higher layer parameter codebookType set to “typeII-PortSelection-r16” for an enhanced Type II CSI reporting in which the pre-coders for all SBs and for a given layer 1=1, . . . ,v, where v is the associated RI value, is given by either:

$${W}^{l} = A {C}_{l} {B}^{H} = {[ \begin{matrix}{a}_{0} & {a}_{1} & … & {a}_{L - 1}\end{matrix} ] [ \begin{matrix}{c}_{l , 0 , 0} & {c}_{l , 0 , 1} & ⋯ & {c}_{l , 0 , M - 1} \\ {c}_{l , 1 , 0} & {c}_{l , 1 , 1} & ⋯ & {c}_{l , 1 , M - 1} \\ ⋮ & ⋮ & ⋮ & ⋮ \\ {c}_{l , L - 1 , 0} & {c}_{l , L - 1 , 1} & ⋯ & {c}_{l , L - 1 , M - 1}\end{matrix} ] [ \begin{matrix}{b}_{0} & {b}_{1} & … & {b}_{M - 1}\end{matrix} ]}^{H} = {\sum }_{f = 0}^{M - 1} {\sum }_{i = 0}^{L - 1} {c}_{l , i , f} ( {a}_{i} {b}_{f}^{H} ) = {\sum }_{i = 0}^{L - 1} {\sum }_{f = 0}^{M - 1} {c}_{l , i , f} ( {a}_{i} {b}_{f}^{H} ) \qquad ( Eq . 1 )$$

$$or$$

$${W}^{l} = [ \begin{matrix}A & 0 \\ 0 & A\end{matrix} ] {C}_{l} {B}^{H} = {[ \begin{matrix}\begin{matrix}{a}_{0} & {a}_{1} & … & {a}_{L - 1}\end{matrix} & 0 \\ 0 & \begin{matrix}{a}_{0} & {a}_{1} & … & {a}_{L - 1}\end{matrix}\end{matrix} ] [ \begin{matrix}{c}_{l , 0 , 0} & {c}_{l , 0 , 1} & ⋯ & {c}_{l , 0 , M - 1} \\ {c}_{l , 1 , 0} & {c}_{l , 1 , 1} & ⋯ & {c}_{l , 1 , M - 1} \\ ⋮ & ⋮ & ⋮ & ⋮ \\ {c}_{l , L - 1 , 0} & {c}_{l , L - 1 , 1} & ⋯ & {c}_{l , L - 1 , M - 1}\end{matrix} ] [ \begin{matrix}{b}_{0} & {b}_{1} & … & {b}_{M - 1}\end{matrix} ]}^{H} = [ \begin{matrix}{\sum }_{f = 0}^{M - 1} {\sum }_{i = 0}^{L - 1} {c}_{l , i , f} ( {a}_{i} {b}_{f}^{H} ) \\ {\sum }_{f = 0}^{M - 1} {\sum }_{i = 0}^{L - 1} {c}_{l , i + L , f} ( {a}_{i} {b}_{f}^{H} )\end{matrix} ] \qquad ( Eq . 2 )$$

In such equations: (1) N₁ is a number of antenna ports in a first antenna port dimension (having the same antenna polarization), (2) N₂ is a number of antenna ports in a second antenna port dimension (having the same antenna polarization, (3) P_{CSI-RS} is a number of CSI-RS ports configured to the UE, (4) N₃ is a number of SBs for PMI reporting or number of FD units or number of FD components (that comprise the CSI reporting band) or a total number of precoding matrices indicated by the PMI (one for each FD unit/component), (5) aᵢ is a 2N₁N₂×1 (Eq. 1) or N₁N₂×1 (Eq. 2) column vector, or aᵢ is a

$${P}_{CSIRS} \times 1 or \frac{{P}_{CSIRS}}{2} \times 1 \qquad ( Eq . 1 )$$

port selection column vector, where a port selection vector is a defined as a vector which contains a value of 1 in one element and zeros elsewhere, (6) b_{f} is a N₃×1 column vector, and (7) c_{l,i,f} is a complex coefficient.

In a variation, when the UE reports a subset K<2LM coefficients (where K is either fixed, configured by the gNB or reported by the UE), then the coefficient c_{l,i,f} in precoder equations Eq. 1 or Eq. 2 is replaced with x_{l,i,f}×c_{l,i,f}, where: (1) x_{l,i,f}=1 if the coefficient c_{l,i,f} is reported by the UE according to some embodiments of the present disclosure, and (2) x_{l,i,f}=0 otherwise (i.e., c_{l,i,f} is not reported by the UE).

The indication whether x_{l,i,f}=1 or 0 is according to some embodiments of the present disclosure. For example, the indication can be via a bitmap.

In a variation, the precoder equations Eq. 1 or Eq. 2 are respectively generalized to

$${W}^{l} = {\sum }_{i = 0}^{L - 1} {\sum }_{f = 0}^{{M}_{i - 1}} {C}_{l , i , f} ( {a}_{i} {b}_{i , f}^{H} ) \qquad ( Eq . 3 )$$

$$and$$

$${W}^{l} = [ \begin{matrix}{\sum }_{i = 0}^{L - 1} {\sum }_{f = 0}^{{M}_{i} - 1} & {c}_{l , i , f} ( {a}_{i} {b}_{i , f}^{H} ) \\ {\sum }_{i = 0}^{L - 1} {\sum }_{= 0}^{{M}_{i} - 1} & {c}_{l , i + L , f} ( {a}_{i} {b}_{i , f}^{H} )\end{matrix} ] \qquad ( Eq . 4 )$$

where for a given i, the number of basis vectors is Mᵢ and the corresponding basis vectors are {b_{i,f}}. Note that Mᵢ is the number of coefficients c_{l,i,f} reported by the UE for a given i, where Mᵢ≤M (where {Mᵢ } or ΣMᵢ is either fixed, configured by the gNB or reported by the UE). The columns of W^{l} are normalized to norm one. For rank R or R layers (υ=R), the pre-coding matrix is given by

$${W}^{( R )} = \frac{1}{\sqrt{R}} [ \begin{matrix}{W}^{1} & {W}^{2} & ⋯ & {W}^{R}\end{matrix} ] .$$

Eq. 2 is assumed in the rest of the disclosure. The embodiments of the disclosure, however, are general and are also application to Eq. 1, Eq. 3 and Eq. 4.

$$Here L \leq \frac{{P}_{CSI - RS}}{2} and M \leq {N}_{3} . If L = \frac{{P}_{CSI - RS}}{2} ,$$

then A is an identity matrix, and hence not reported. Likewise, if M=N₃, then B is an identity matrix, and hence not reported. Assuming M< N₃, in an example, to report columns of B, the oversampled DFT codebook is used. For instance, b_{f}=w_{f}, where the quantity w_{f} is given by

$${w}_{f} = {[ \begin{matrix}1 & {e}^{j \frac{2 π {n}_{3 , l}^{( f )}}{{O}_{3} {N}_{3}}} {e}^{j \frac{2 π \text{.2} {n}_{3 , l}^{( f )}}{{O}_{3} {N}_{3}}} & … & {e}^{j \frac{2 π . ( {N}_{3} - 1 ) {n}_{3 , l}^{( f )}}{{O}_{3} {N}_{3}}}\end{matrix} ]}^{T} .$$

When O₃=1, the FD basis vector for layer l∈{1, . . . , υ} (where υ is the RI or rank value) is given by w_{f}=[y_{0,l}^{(f)} y_{1,l}^{. . . y}_{N}_{₂}_{-1,l}^{(f)}]^{T}, where

$${y}_{t , l}^{( f )} = {e}^{j \frac{2 π {tn}_{3 , l}^{( f )}}{{N}_{3}}}$$

n_{3,l}=[n_{3,l}⁽⁰⁾, . . . , n_{3,l}^{(M-1)}] where n_{3,l}^{(f)}∈{0,1, . . . , N₃−1}.

In another example, discrete cosine transform DCT basis is used to construct/report basis B for the 3^{rd} dimension. The m-th column of the DCT compression matrix is simply given by

$${[ {W}_{f} ]}_{nm} = \{ \begin{matrix}\frac{1}{\sqrt{K}} , & n = 0 \\ \sqrt{\frac{2}{K}} cos \frac{π ( 2 m + 1 ) n}{2 K} , & n = 1 , … K - 1\end{matrix} ,$$

and K=N₃, and m=0, . . . , N₃−1.

Since DCT is applied to real valued coefficients, the DCT is applied to the real and imaginary components (of the channel or channel eigenvectors) separately. Alternatively, the DCT is applied to the magnitude and phase components (of the channel or channel eigenvectors) separately. The use of DFT or DCT basis is for illustration purpose only. The disclosure is applicable to any other basis vectors to construct/report A and B.

On a high level, a precoder W^{l} can be described as follows:

W=AₗCₗBₗ^{H}=W₁−\tilde{W}₂W_{f}^{H}, (Eq. 5)

where A=W₁ corresponds to the Rel. 15 W₁ in Type II CSI codebook as shown in 3GPP standard specification, and B=1/17 f .

The Cₗ=\tilde{W}₂ matrix consists of all the required linear combination coefficients (e.g., amplitude and phase or real or imaginary). Each reported coefficient (c_{l,i,f}=in \tilde{W}₂ is quantized as amplitude coefficient (p_{l,i,f}) and phase coefficient (ϕ_{l,i,f}) . In one example, the amplitude coefficient (p_{l,i,f}) is reported using a A-bit amplitude codebook where A belongs to {2, 3, 4}. If multiple values for A are supported, then one value is configured via higher layer signaling.

In another example, the amplitude coefficient (p_{l,i,f}) is reported as p_{l,i,f}=p_{l,i,f}⁽¹⁾p_{l,i,f}⁽²⁾ where: (1)p_{l,i,f}⁽¹⁾ is a reference or first amplitude which is reported using a Al-bit amplitude codebook where A1 belongs to {2, 3, 4}, and (2) p_{l,i,f}⁽²⁾ is a differential or second amplitude which is reported using a A2-bit amplitude codebook where A2≤A1 belongs to {2, 3, 4}.

For layer l, let us denote the linear combination (LC) coefficient associated with spatial domain (SD) basis vector (or beam) i∈{0,1, ... ,2L - 1} and frequency domain (FD) basis vector (or beam) f E {0,1, . . . , M−1} as c_{l,i,f}, and the strongest coefficient as c_{l,i*f*}. The strongest coefficient is reported out of the K_{NZ} non-zero (NZ) coefficients that is reported using a bitmap, where K_{NZ}≤K₀=┌β×2LM┐<2LM and β is higher layer configured. The remaining 2LM -K_{NZ} coefficients that are not reported by the UE are assumed to be zero.

The following quantization scheme is used to quantize/report the K_{NZ} NZ coefficients.

In one example, a UE reports the following for the quantization of the NZ coefficients in \tilde{W}₂: (1) a X-bit indicator for the strongest coefficient index (i*, f*), where X=┌log₂K_{NZ}┐ or ┌log_{2 2}L┐: (i) strongest coefficient c_{l,i*f*}=1 (hence its amplitude/phase are not reported); (2) two antenna polarization-specific reference amplitudes are used: (i) for the polarization associated with the strongest coefficient c_{l,i*f*}=1, since the reference amplitude p_{l,i,f}⁽¹⁾=1, it is not reported; and (ii) for the other polarization, reference amplitude p_{l,i,f}⁽¹⁾ is quantized to 4 bits. In such instance, the 4-bit amplitude alphabet is

$$\{ 1 , {( \frac{1}{2} )}^{\frac{1}{4}} , {( \frac{1}{4} )}^{\frac{1}{4}} , {( \frac{1}{8} )}^{\frac{1}{4}} , … , {( \frac{1}{{2}^{14}} )}^{\frac{1}{4}} \} ;$$

(3) for {c_{l,i,f},(i, f)≠(i*, f*)}: (i) for each polarization, differential amplitudes p_{l,i,f}⁽²⁾ of the coefficients calculated relative to the associated polarization-specific reference amplitude and quantized to 3 bits, in such instance, the 3-bit amplitude alphabet is

$$\{ 1 , \frac{1}{\sqrt{2}} , \frac{1}{2} , \frac{1}{2 \sqrt{2}} , \frac{1}{4} , \frac{1}{4 \sqrt{2}} , \frac{1}{8} , \frac{1}{8 \sqrt{2}} \} .$$

Note: the final quantized amplitude p_{l,i,f} is given by p_{l,i,f}⁽¹⁾×p_{l,i,f}⁽²⁾; and (ii) each phase is quantized to either 8PSK (Nₚₕ=8) or 16PSK (Nₚₕ=16) (which is configurable).

For the polarization r*∈{0,1} associated with the strongest coefficient c_{l,i*f*}, there may be

$${r}^{*} = ⌊ \frac{{i}^{*}}{L} ⌋$$

and the reference amplitude p_{l,i,f}⁽¹⁾=p_{l,r*}⁽¹⁾=1. For the other polarization r∈{0,1} and r≠r*, there may be

$$r = ( ⌊ \frac{{i}^{*}}{L} ⌋ + 1 )$$

mod 2 and the reference amplitude p_{l,i,f}⁽¹⁾=p_{l,r}⁽¹⁾ quantized (reported) using the 4-bit amplitude codebook mentioned above.

In Rel. 16 enhanced Type II and Type II port selection codebooks, a UE can be configured to report M FD basis vectors. In one example,

$$M = ⌈ p \times \frac{{N}_{3}}{R} ⌉ ,$$

where R is higher-layer configured from {1, 2} and p is higher-layer configured from {¼, ½}. In one example, the p value is higher-layer configured for rank 1-2 CSI reporting. For rank >2 (e.g., rank 3-4), the p value (denoted by v₀) can be different. In one example, for rank 1-4, (p, v₀) is jointly configured from {(½, ¼), (¼, ¼), (¼, ⅛)}, i.e.,

$$M = ⌈ p \times \frac{{N}_{3}}{R} ⌉$$

for rank 1-2 and

$$M = ⌈ {v}_{0} \times \frac{{N}_{3}}{R} ⌉$$

for rank 3-4. In one example, N₃=N_{SB}×R where N_{SB} is the number of SBs for CQI reporting. In one example, M is replaced with Mᵥ to show its dependence on the rank value v, hence p is replaced with pᵥ, v∈{1, 2} and v₀ is replaced with pᵥ, v∈{3, 4}.

A UE can be configured to report My FD basis vectors in one-step from N₃ basis vectors freely (independently) for each layer l∈{1, . . . , v} of a rank u CSI reporting. Alternatively, a UE can be configured to report My FD basis vectors in two-step as follows: (1) in step 1, an intermediate set (InS) comprising Ng <N3 basis vectors is selected/reported, wherein the InS is common for all layers; and (2) in step 2, for each layer l∈{1, .. , v} of a rank v CSI reporting, My FD basis vectors are selected/reported freely (independently) from Ng basis vectors in the InS.

In one example, one-step method is used when N₃≤19 and two-step method is used when N₃>19. In one example, N′₃=[αMᵥ] where α>1 is either fixed (to 2 for example) or configurable.

The codebook parameters used in the DFT based frequency domain compression (eq. 5) are (L, pᵥ for v∈{1,2}, pᵥ forv ∈{3,4}, β, α, Nₚₕ). The set of values for these codebook parameters are as follows: (1) L: the set of values is {2,4} in general, except L∈{2,4,6} for rank 1-2, 32 CSI-RS antenna ports, and =1 ; (2) (pᵥ for v ∈{1,2}, pᵥ for v∈{3,4})∈{(½, ¼), (¼, ¼), (¼, ⅛)}; (3)β∈{(¼, ½, ¾}; (4) α=2; and (5) Nₚₕ=16.

The set of values for these codebook parameters are as in TABLE 1.

TABLE 1
Values for the codebook parameters

| | | p_{υ} | | |
|---|---|---|---|---|
| paramCombination-r16 | L | υ ∈ {1, 2} | υ ∈ {3, 4} | β |
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |
| 7 | 6 | ¼ | — | ½ |
| 8 | 6 | ¼ | — | ¾ |

In Rel. 17 (further enhanced Type II port selecting codebook), M∈{1,2},

$$L = \frac{{K}_{1}}{2}$$

where K₁=α×P_{CSIRS}, and codebook parameters (M, α, β) are configured from TABLE 2.

TABLE 2
Values for the codebook parameters

| paramCombination-r17 | M | α | β |
|---|---|---|---|
| 1 | 1 | ¾ | ½ |
| 2 | 1 | 1 | ½ |
| 3 | 1 | 1 | ¾ |
| 4 | 1 | 1 | 1 |
| 5 | 2 | ½ | ½ |
| 6 | 2 | ¾ | ½ |
| 7 | 2 | 1 | ½ |
| 8 | 2 | 1 | ¾ |

The above-mentioned framework (e.g., Eq. 5) represents the precoding-matrices for multiple (N₃) FD units using a linear combination (double sum) over 2L (or K1) SD beams/ports and My FD beams. This framework can also be used to represent the precoding-matrices in time domain (TD) by replacing the FD basis matrix W_{f} with a TD basis matrix Wₜ, wherein the columns of Wₜ comprises My TD beams that represent some form of delays or channel tap locations. Hence, a precoder W^{l} can be described as follows:

W 32 AₗCₗBₗ^{H}=W₁\tilde{W}₂Wₜ^{H}, (5A)

In one example, the Mᵥ TD beams (representing delays or channel tap locations) are selected from a set of N₃ TD beams, i.e., N₃ corresponds to the maximum number of TD units, where each TD unit corresponds to a delay or channel tap location. In one example, a TD beam corresponds to a single delay or channel tap location. In another example, a TD beam corresponds to multiple delays or channel tap locations. In another example, a TD beam corresponds to a combination of multiple delays or channel tap locations.

In one example, the codebook for the CSI report is according to at least one of the following examples.

In one example, the codebook can be a Rel. 15 Type I single-panel codebook (e.g., as illustrated in TS 38.214).

In one example, the codebook can be a Rel. 15 Type I multi-panel codebook (e.g., as illustrated in TS 38.214).

In one example, the codebook can be a Rel. 15 Type II codebook (e.g., as illustrated in TS 38.214).

In one example, the codebook can be a Rel. 15 port selection Type II codebook (e.g., as illustrated in TS 38.214).

In one example, the codebook can be a Rel. 16 enhanced Type II codebook (e.g., as illustrated in TS 38.214).

In one example, the codebook can be a Rel. 16 enhanced port selection Type II codebook (e.g., as illustrated in TS 38.214).

In one example, the codebook can be a Rel. 17 further enhanced port selection Type II codebook (e.g., as illustrated in TS 38.214).

In one example, the codebook is a new codebook for C-JT CSI reporting.

In one example, the new codebook is a decoupled codebook comprising the following components: (called “CB1” hereafter): (1) intra-TRP: per TRP Rel. 16/17 Type II codebook components, i.e., SD basis vectors (W1), FD basis vectors (Wf), W2 components (e.g., SCI, indices of NZ coefficients, and amplitude/phase of NZ coefficients) and (2) inter-TRP: co-amplitude and co-phase for each TRP.

In one example, the new codebook is a joint codebook (called “CB2” hereafter) comprising following components: (1) per TRP SD basis vectors (W1); (2) single joint FD basis vectors (Wf); and (3) single joint W2 components (e.g., SCI, indices of NZ coefficients, and amplitude/phase of NZ coefficients).

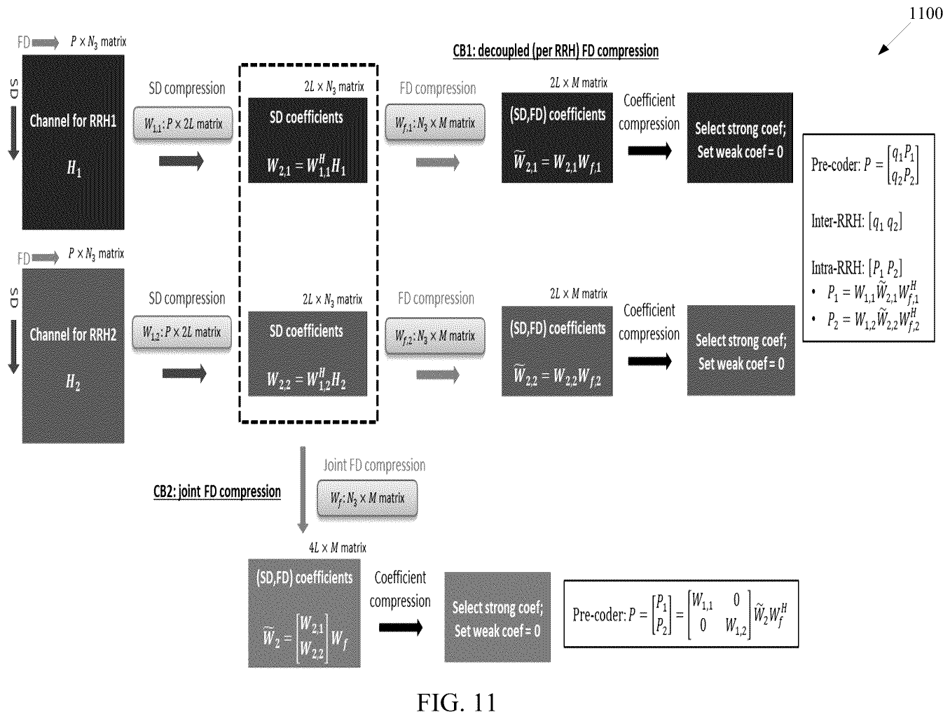

Two new codebooks are illustrated in FIG. 11.

FIG. 11 illustrates an example of codebook 1100 according to embodiments of the present disclosure. An embodiment of the codebook 1100 shown in FIG. 11 is for illustration only.

In one example, when the codebook is a legacy codebook (e.g., one of Rel. 15/16/17 NR codebooks, according to one of the examples above), then the CSI reporting is based on a CSI resource set comprising one or multiple NZP CSI-RS resource(s), where each NZP CSI-RS resource comprises CSI-RS antenna ports for all TRPs/RRHs, i.e., P=Σᵣ₌₁^{N}Pᵣ, where P is the total number of antenna ports, and Pᵣ is the number of antenna ports associated with r-th TRP. In this case, a TRP corresponds to (or maps to or is associated with) a group of antenna ports.

In one example, when the codebook is a new codebook (e.g., one of the two new codebooks above), then the CSI reporting is based on a CSI resource set comprising one or multiple NZP CSI-RS resource(s).

In one example, each NZP CSI-RS resource comprises CSI-RS antenna ports for all TRPs/RRHs. i.e., P=Σᵣ₌₁^{N}Pᵣ, where P is the total number of antenna ports, and Pᵣ is the number of antenna ports associated with r-th TRP. In this case, a TRP corresponds to (or maps to or is associated with) a group of antenna ports.

In one example, each NZP CSI-RS resource corresponds to (or maps to or is associated with) a TRP/RRH (a TRP-group).

In the present disclosure, it may use N, N_{TRP}, N_{RRH} interchangeably for a number of TRPs/RRHs.

In one embodiment, a UE is configured with a CSI reporting based on an mTRP (or D-MIMO or C-JT) codebook, via e.g., higher layer parameter codebookType set to “typeII-r18-cjt” or “typeII-PortSelection-r18-cjt,” where the codebook is one of the following two modes: In one example, one of the two modes is configured, e.g., via higher layer (e.g., via parameter codebookMode).

In one example of Mode 1, per-TRP/TRP-group (or per-CSI-RS resource) SD/FD basis selection. Example formulation (N_{TRP}=number of TRPs or TRP groups): The UE reports (i) SD basis vectors for each TRP, (ii) FD basis vectors for each TRP, and (iii) either a joint W2 across all TRPs or one W2 for each TRP:

$$[ \begin{matrix}{W}_{1 , 1} {\tilde{W}}_{2 , 1} {W}_{f , 1}^{H} \\ ⋮ \\ {W}_{1 , N} {\tilde{W}}_{2 , N} {W}_{f , N}^{H}\end{matrix} ] .$$

In one example of Mode 2, per-TRP/TRP group (port-group or resource) SD basis selection and joint (across N_{TRP} TRPs) FD basis selection. Example formulation (N_{TRP}=number of TRPs or TRP groups): The UE reports (i) SD basis vectors for each TRP, (ii) one common/joint FD basis vectors across all TRPs, and (iii) either a joint W2 across all TRPs or one W2 for each TRP:

$$[ \begin{matrix}{W}_{1 , 1} & 0 & 0 & 0 \\ 0 & ⋱ & 0 & 0 \\ 0 & 0 & & \\ 0 & 0 & & {W}_{1 , N}\end{matrix} ] {\tilde{W}}_{2} {W}_{f}^{H} or [ \begin{matrix}{W}_{1 , 1} {\tilde{W}}_{2 , 1} {W}_{f}^{H} \\ ⋮ \\ {W}_{1 , N} {\tilde{W}}_{2 , N} {W}_{f}^{H}\end{matrix} ]$$

where it may use N and NTRP interchangeably.

In one example, Mode 1 can be the codebook described in U.S. patent application Ser. No. 18/310,396, as incorporate herein by reference in its entirety, and Mode 2 can be the codebook described in embodiment as described in U.S. patent application Ser. No. 18/310,396, as incorporate herein by reference in its entirety.

In one example, the two modes can share similar detailed designs such as parameter combinations, basis selection, TRP (group) selection, reference amplitude, \tilde{W}₂ quantization schemes.

In one example, parameter combinations can be a tuple of parameters such as L, pᵥ, β for regular Type-II CJT codebook or a tuple of parameters such as M, α, β for port-selection Type-II CJT codebook.

In one example, basis selection scheme can be SD basis selection and/or FD basis selection schemes described in embodiment 1 as described in U.S. patent application Ser. No. 18/310,396, as incorporate herein by reference in its entirety.

In one example, a TRP selection can be one component/example described in U.S. as described in U.S. patent application Ser. No. 18/295,219, as incorporate herein by reference in its entirety.

In one example, a reference amplitude scheme can be one component/example described in as described in U.S. patent application Ser. No. 18/305,241, as incorporate herein by reference in its entirety.

In one example, a \tilde{W}₂ quantization scheme can include strongest coefficient indicator, upper bound of non-zero coefficients, reference amplitudes, a scheme that each coefficient is decomposed into phase and amplitude and they are selected respective codebooks, and a codebook subset restriction.

In Rel-16/17 Type-II CSI reporting, the mapping order of CSI fields of one CSI report, CSI part 1, is given by 3GPP TS 38.212, which is as follows.

TABLE 3
Mapping order of CSI fields of one CSI report, CSI part 1

| CSI report | |
|---|---|
| number | CSI fields |
| CSI report #n | CRI as in Tables 6.3.1.1.2-3/4/6, if reported |
| CSI part 1 | Rank Indicator as in Tables 6.3.1.1.2-3/4/5 or 6.3.2.1.2-8/9, if reported |
| | Wideband CQI for the first TB as in Tables 6.3.1.1.2-3/4/5 or 6.3.2.1.2- |
| | 8/9, if reported |
| | Subband differential CQI for the first TB with increasing order of |
| | subband number as in Tables 6.3.1.1.2-3/4/5 or 6.3.2.1.2-8/9, if reported |
| | Indicator of the number of non-zero wideband amplitude coefficients M₀ |
| | for layer 0 as in Table 6.3.1.1.2-5, if reported |
| | Indicator of the number of non-zero wideband amplitude coefficients M₁ |
| | for layer 1 as in Table 6.3.1.1.2-5 (if the rank according to the reported |
| | RI is equal to one, this field is set to all zeros), if 2-layer PMI reporting |
| | is allowed according to the rank restriction in Clauses 5.2.2.2.3 and |
| | 5.2.2.2.4 [6, TS 38.214] and if reported |
| | Indicator of the total number of non-zero coefficients summed across all |
| | layers K^{NZ} as in Table 6.3.2.1.2-8/9, if reported |

Note:
Subbands for given CSI report n indicated by the higher layer parameter csi-ReportingBand are numbered continuously in the increasing order with the lowest subband of csi-ReportingBand as subband 0.

In Rel-16 Type-II CSI reporting, the mapping order of CSI fields of one CSI report. CSI part 2. is given by 3GPP TS38.212, which is as follows:

TABLE 4
Mapping order of CSI fields of one CSI report, CSI part 2 of codebookType=typeII-
r16 or typeII-PortSelection-r16

| CSI report number | CSI fields |
|---|---|
| CSI report #n | PMI fields X₁, from left to right as in Tables 6.3.2.1.2-1A/2A, if |
| CSI part 2, group 0 | reported |
| CSI report #n | The following PMI fields X₂, from left to right, as in Tables 6.3.2.1.2- |
| CSI part 2, group 1 | $1 A / 2 A : \{ {i}_{2 , 3 , l} : l = 1 , … , υ \} , {i}_{1 , 5} , \{ {i}_{1 , 6 , l} : l = 1 , … , υ \} and max ( 0 , ⌈ \frac{{K}^{N Z}}{2} ⌉ - υ ) \times 3$ |
| | $\{ {i}_{2 , 4 , l} : l = 1 , … , υ \} , max ( 0 , ⌈ \frac{{K}^{N Z}}{2} ⌉ - υ ) \times 4 highest priority bits of$ |
| | {i_{2,5,l}: l = 1, ... , υ}, and v * 2LM_{υ} − └K^{NZ}/2┘ highest priority bits |
| | of{i_{1,7,l}: l = 1, ... , υ}, in decreasing order of priority based on the |
| | corresponding function Pri(l, i, f) defined in clause 5.2.3 of TS38.214, |
| | if reported |
| CSI report #n | The following PMI fields X₂, from left to right, as in Tables 6.3.2.1.2- |
| CSI part 2, group 2 | $1 A / 2 A : min ( {K}^{NZ} - v , ⌊ \frac{{K}^{N Z}}{2} ⌋ ) \times 3 lowest priority bits of \{ {i}_{2 , 4 , l} : l =$ |
| | $1 , … , υ \} , min ( {K}^{NZ} - v , ⌊ \frac{{K}^{N Z}}{2} ⌋ ) \times 4 lowest priority bits of \{ {i}_{2 , 4 , l} : l =$ |
| | 1, ... , υ] and └K^{NZ}/2┘ lowest priority bits of {i_{1,7,l}: l = 1, ... , υ}, in |
| | decreasing order of priority based on the corresponding function |
| | Pri(l, i, f) defined in clause 5.2.3 of TS38.214, if reported |

In Rel-16 Type-II CSI reporting. the mapping order of CSI fields of one CSI report. CSI part 2. is given by 3GPP TS 38.212, which is as follows:

TABLE 5
Mapping order of CSI fields of one CSI report, CSI part 2 of codebookType=typeII-
PortSelection-r17

| CSI report number | CSI fields |
|---|---|
| CSI report #n | PMI fields X₁, from left to right as in Tables 6.3.2.1.2-2B, if reported |
| CSI part 2, group 0 | |
| CSI report #n | The following PMI fields X₂, from left to right, as in Tables |
| CSI part 2, group 1 | $6.3 \text{.2} \text{.1} \text{.2} - 2 B : \{ {i}_{2 , 3 , l} : l = 1 , … , υ \} ( max ( 0 , ⌈ \frac{{K}^{N Z}}{2} ⌉ - υ ) ) \times 3 highest$ |
| | priority bits of |
| | $\{ {i}_{2 , 4 , l} : l = 1 , … , υ \} , max ( 0 , ⌈ \frac{{K}^{N Z}}{2} ⌉ - υ ) \times 4 highest priority bits of$ |
| | {i_{2,5,l}: l = 1, ... , υ} and v * K₁M − └K^{NZ}/2┘ highest priority bits |
| | of{i_{1,7,l}: l = 1, ... , υ}, in decreasing order of priority based on the |
| | corresponding function Pri(l, i, f) defined in clause 5.2.3 of |
| | TS38.214, if reported |
| CSI report #n | The following PMI fields X₂, from left to right, as in Tables |
| CSI part 2, group 2 | $6.3 \text{.2} \text{.1} \text{.2} - 2 B : ( min ( {K}^{NZ} - v , ⌊ \frac{{K}^{N Z}}{2} ⌋ ) ) \times 3 lowest priority bits of$ |
| | $\{ {i}_{2 , 4 , l} : l = 1 , … , υ \} , ( min ( {K}^{NZ} - v , ⌈ \frac{{K}^{N Z}}{2} ⌉ ) ) \times 4 lowest priority bits of$ |
| | {i_{2,5,l}: l = 1, ... , υ} and └K^{NZ}/2┘ lowest priority bits of |
| | {i_{1,7,l}: l = 1, ... , υ], in decreasing order of priority based on the |
| | corresponding function Pri(l, i, f) defined in clause 5.2.3 of |
| | TS38.214, if reported |

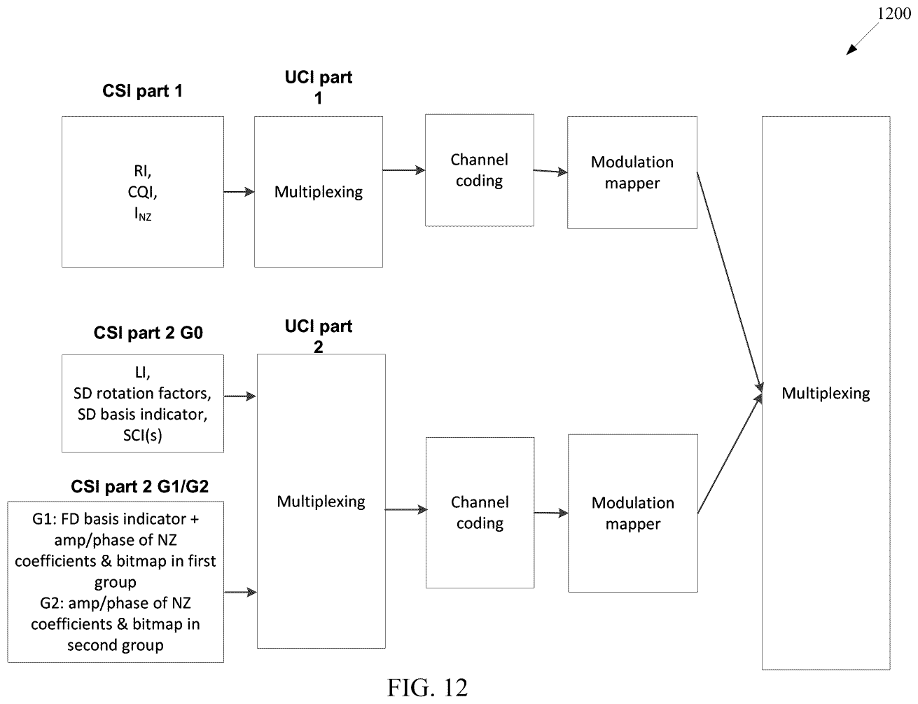

FIG. 12 illustrates an example of UCI used to multiplex and report CSI 1200 according to embodiments of the present disclosure. An embodiment of the UCI used to multiplex and report CSI 1200 shown in FIG. 12 is for illustration only.

In one embodiment 1, the two-part UCI (FIG. 12) is used to multiplex and report CSI comprising CSI part 1 and CSI part 2 according to above-mentioned framework, e.g., Mode 1/Mode 2 codebooks, wherein following embodiments and examples can be provided.

In one embodiment, CSI part 1 comprising CQI, RI, and I_{NZ} are multiplexed and encoded together in UCI part 1, where I_{NZ} is an indicator regarding the number of non-zero (NZ) coefficients. (at least one of the following examples can be considered).

In one example, the indicator I_{NZ} is either a joint indicator or comprises separate indicators to indicate vN values of (K_{1,1}^{NZ}, . . . , K_{v,1}^{NZ}, K_{1,2}^{NZ}, . . . , K_{v,2}^{NZ}, . . ., K_{v,N}^{NZ}), where K_{l,r}^{NZ} indicates a number of non-zero (NZ) coefficients for layer l and for TRP (CSI-RS resource) r.

In one example, the indicator I_{NZ} is either a joint indicator or comprises separate indicators to indicate N values of (Σₗ₌₁^{v}K_{l,1}^{NZ}, . . . , Σₗ₌₁^{v}K_{l,N}^{NZ}).

In one example, the indicator I_{NZ} is either a joint indicator or comprises separate indicators to indicate v values of (Σᵣ₌₁^{N}K_{1,r}^{NZ}, . . . , Σᵣ₌₁^{N}K_{v,r}^{NZ}).

In one example, the indicator I_{NZ} indicates a value of K^{NZ}=Σᵣ₌₁^{N}Σₗ₌₁^{v}Σ_{l,r}^{NZ}.

In one example, the indicator I_{NZ} is either a joint indicator or comprises separate indicators to indicate n∈[1, N] values of (Σₗ₌₁^{v}K_{l,1}^{NZ}, . . . , Σₗ₌₁^{v}K_{l,N}^{NZ}). In one example, n is fixed or determined in a pre-defined rule, or configured by NW, or determined by UE and reported as a part of CSI. If n is determined by UE, in one example, CSI part 1 further includes an indicator to indicate n, where the size of the indicator is ┌log₂ N┐. In one example, n can be computed by counting “1” (or “0”) in an N-bit bitmap.

In one example, the indicator I_{NZ} is either a joint indicator or comprises separate indicators to indicate v values of (Σᵣ₌₁^{N}K_{1,r}^{NZ}, . . . , Σᵣ₌₁^{N}K_{v,r}^{NZ}), where n∈[1, N]. In one example, n is fixed or determined in a pre-defined rule, or configured by NW, or determined by UE and reported as a part of CSI. If n is determined by UE, in one example, CSI part 1 further includes an indicator to indicate n, where the size of the indicator is ┌log₂ N┐. In one example, this indicator is CRI. In one example, n can be computed by counting “1” (or “0”) in an N-bit bitmap.

In one example, the indicator I_{NZ} indicates K^{NZ}=Σᵣ₌₁^{N}Σₗ₌₁^{v}Σ_{l,r}^{NZ}, where n∈[1, N]. In one example, n is fixed or determined in a pre-defined rule, or configured by NW, or determined by UE and reported as a part of CSI. If n is determined by UE, in one example, CSI part 1 further includes an indicator to indicate n, where the size of the indicator is ┌log₂ N┐. In one example, this indicator is CRI. In one example, n can be computed by counting “1” (or “0”) in an N-bit bitmap. In one example, CSI part 1 includes one CRI (CSI-RS indicator), where the size of CRI is ┌log₂ N┐.

In one example, CSI part 1 includes one or multiple (n≥1) CRIs, where the size of CRIs is ┌log₂ (ₙ^{N})┐ or N bits (i.e., a bitmap of length N). In one example, n is fixed or determined in a pre-defined rule, or configured by NW, or determined by UE and reported as a part of CSI. If n is determined by UE, in one example, CSI part 1 further includes an indicator to indicate n, where the size of the indicator is ┌log₂ N┐.

In one example, CSI part 1 includes a bitmap of size N (e.g., TRP selection).

In one example, CSI part 1 includes an order of CRIs (CRI ordering) among N TRPs (CSI-RS resources), where the size of the order of CRIs is ┌log₂ N!┐.

In one example, CSI part 1 includes an order of CRIs (CRI ordering) among n(∈[1, N]) TRPs (CSI-RS resources), where the size of the order of CRIs is ┌log₂ n!┐.In one example, n is fixed or determined in a pre-defined rule, or configured by NW, or determined by UE and reported as a part of CSI. If n is determined by UE, in one example, CSI part 1 further includes an indicator to indicate n, where the size of the indicator is ┌log₂ N┐.

In one example, CSI part 1 includes an order of CRIs (CRI ordering) among n(∈[1, N]) TRPs (CSI-RS resources), where the size of the order of CRIs is ┌log₂ P(N,n)┐ and P(N,n) is

$$\frac{N !}{( N - n ) !} .$$

In one example, CSI part 1 includes an indicator [symbol] regarding the number(s) of SD vectors Lᵣ for r=1, . . . , N (e.g., when reporting Lᵣs corresponding to all configured TRPs (CSI-RS resources)).

In one example, the indicator [symbol] is a joint indicator or comprises separate indicators to indicate N values of (L₁, . . . , L_{N}).

In one example, the indicator [symbol] is a joint indicator or comprises separate indicators to indicate N−1 values of (L₁, . . . , L_{N}). In this case, LN can be determined based on (L₁, . . . , L_{N}) and Lₛᵤₘ=Σᵣ₌₁^{N}Lᵣ, if Lₛᵤₘ is configured.

In one example, the indicator [symbol] is a joint indicator or comprises separate indicators to indicate N values of (L_{ϕ(1)}, . . . , L_{ϕ(N)}), where ϕ(·) is a permutation function, e.g., to reorder the TRP indices (CSI-RS resources) for reporting. For example, ϕ(·) can be determined based on CRI ordering in CSI Part 1.

In one example, the indicator [symbol] is a joint indicator or comprises separate indicators to indicate N−1 values of (L_{ϕ(1)}, . . . , L_{ϕ(N-1)}), where ϕ(·) is a permutation function, e.g., to reorder the TRP indices (CSI-RS resources) for reporting. For example, ϕ(·) can be determined based on CRI ordering in CSI Part 1. In this case, L_{ϕ(N)} can be determined based on (L_{ϕ(1)}, . . . , L_{ϕ(N-1)}) and Lₛᵤₘ=Σᵣ₌₁^{N}Lᵣ, if Lₛᵤₘ is configured.

In one example, CSI part 1 includes an indicator [symbol] regarding the number(s) of SD vectors Lᵣ for r∈S, where S is a subset of {1, . . . , N} (e.g., when reporting Lrs corresponding to a selected set of TRPs).

In one example, the indicator [symbol] is a joint indicator or comprises separate indicators to indicate |S| values of {Lᵣ}_{r∈S}.

In one example, the indicator [symbol] is a joint indicator or comprises separate indicators to indicate |S|−1 values of {Lᵣ}_{r∈S} excluding one Lᵣ, e.g., the L, corresponding to the last TRP index of r in S. In this case, the excluded Lᵣ can be determined based on [symbol] is and Lₛᵤₘ=Σᵣ₌₁^{N}Lᵣ, if Lₛᵤₘ is configured.

In one example, the indicator [symbol] is a joint indicator or comprises separate indicators to indicate N values of {L_{ϕ(r)}}_{r∈S}, where (·) is a permutation function, e.g., to reorder the TRP indices (CSI-RS resources) for reporting. For example, ø(·) can be determined based on CRI ordering in CSI Part 1.

In one example, the indicator [symbol] is a joint indicator or comprises separate indicators to indicate N−1 values of {L_{ϕ(r)}}_{r∈S} excluding one L_{ϕ(r)}e.g., the Lo(r) corresponding to the last TRP index of r in S where @(·) is a permutation function, e.g., to reorder the TRP indices (CSI-RS resources) for reporting. For example, ¢(·) can be determined based on CRI ordering in CSI Part 1. In this case, the excluded L_{ϕ(r)} can be determined based on L and Lₛᵤₘ=Σᵣ₌₁^{N}Lᵣ, if Lₛᵤₘ is configured

In one example, CSI part 1 includes an indicator [symbol] regarding the number(s) of SD vectors Lᵣ for r=1, . . . , N, where the indicator [symbol] is a joint indicator or comprises separate indicators to indicate 2 values of L̅₁ and L̅₂, where L̅₁ is L value for a first TRP-group of {1, . . . , N} and L̅₂ is L value for a second TRP-group of {1, . . . , N}. It can be according to at least one of the following examples.

In one example, the first group includes a strongest/reference TRP and the second group includes all TRPs excluding the strongest/reference TRP.

In one example, the first group includes two stronger TRPs and the second group includes all TRPs excluding the two stronger TRPs.

In one example, only when N≥x, the example can be applied, where e.g., x=3 and/or 4.

In one example, CSI part 1 includes an indicator [symbol] regarding the number(s) of SD vectors Lᵣ for r E S, where the indicator [symbol] is a joint indicator or comprises separate indicators to indicate 2 values of L̅₁ and L̅₂, where L̅₁ is L value for a first TRP-group of S and L̅₂ is L value for a second TRP-group of S. It can be according to at least one of the following examples.

In one example, the first group includes a strongest/reference TRP and the second group includes all TRPs in S excluding the strongest/reference TRP.

In one example, the first group includes two stronger TRPs and the second group includes all TRPs in S excluding the two stronger TRPs.

In one example, only when N≥x, the example can be applied, where e.g., x=3 and/or 4 .

In another embodiment, CSI part 2 comprising LI, the first PMI i₁ and the second PMI i2 are multiplexed and encoded together in UCI part 2.

In one embodiment, the CSI part 2 is segmented in two segments or three groups. The three groups of the CSI part 2 are denoted by G0, G1, and G2.

In one example, the CSI part 2 group 0 (G0) can be according to at least one of the following examples (e.g., for the case of a single value of L) .

In one example, G0 includes LI, and SD rotation factors indicating (q₁, q₂) (e.g., one i_{1,1} across TRPs), SD basis indicator indicating L vector selection (e.g., one 11,2 indicating L SD vectors across TRPs), and SCI (e.g., one i_{1,8,l} across TRPs).

In one example, G0 includes LI, and SD rotation factors indicating (q₁, q₂) (e.g., one i_{1,1} across TRPs), SD basis indicator indicating L beam selection for each TRP r (e.g., one i_{1,2,r} indicating L SD vectors for each TRP), and SCI (e.g., one i_{1,8,l} across TRPs).

In one example, G0 includes LI, and SD rotation factors indicating (q₁, q₂) (e.g., one i_{1,1} across TRPs), SD basis indicator indicating L beam selection (e.g., one i_{1,2} indicating L SD vectors across TRPs), and one SCI for each TRP r (e.g., one i_{1,8,l,r} each TRP).

In one example, G0 includes LI, and SD rotation factors indicating (q₁, q₂) (e.g., one i_{1,1} across TRPs), SD basis indicator indicating L beam selection for each TRP r (e.g., one i_{1,2,r} indicating L SD vectors for each TRP), and one SCI for each TRP r (e.g., one i_{1,8,l,r} each TRP).

In one example, G0 includes LI, and SD rotation factors indicating (q_{1,r}, q_{2,r}) for each TRP r (e.g., one i_{1,1,r} for each TRP), SD basis indicator indicating L beam selection (e.g., one i_{1,2} across TRPs), and SCI (e.g., one i_{1,8,l} across TRPs).

In one example, G0 includes LI, and SD rotation factors indicating (q_{1,r}, q_{2,r}) for each TRP r (e.g., one i_{1,1,r} for each TRP), SD basis indicator indicating L beam selection for each TRP r (e.g., one i_{1,2,r} for each TRP), and SCI (e.g., one i_{1,8,l} across TRPs).

In one example, G0 includes LI, and SD rotation factors indicating (q_{1,r}, q_{2,r}) for each TRP r (e.g., one i_{1,1,r} for each TRP), SD basis indicator indicating L beam selection (e.g., one i_{1,2} across TRPs), and one SCI for each TRP r (e.g., one i_{1,8,l,r} each TRP).

In one example, G0 includes LI, and SD rotation factors indicating (q_{1,r}, q_{2,r}) for each TRP r (e.g., one i_{1,1,r} for each TRP), SD basis indicator indicating L beam selection for each TRP r (e.g., one i_{1,2,r} for each TRP), and one SCI for each TRP r (e.g., one i_{1,8,l,r} each TRP) (e.g., for the case of multiple values of L).

In one example, G0 includes LI, and SD rotation factors indicating (q₁, q₂) (e.g., one i_{1,1} across TRPs), SD basis indicator indicating Lᵣ vector selection for each TRP r (e.g., one i_{1,2,r} indicating Lᵣ SD vectors for each TRP), and SCI (e.g., one (1,8,1 across TRPs).

In one example, G0 includes LI, and SD rotation factors indicating (q₁, q₂) (e.g., one i_{1,1} across TRPs), SD basis indicator indicating Lᵣ vector selection for each TRP r (e.g., one i_{1,2,r} indicating Lᵣ SD vectors for each TRP), and one SCI for each TRP r (e.g., one i_{1,8,l,r} each TRP).

In one example, G0 includes LI, and SD rotation factors indicating (q_{1,r}, q_{2,r}) for each TRP r (e.g., one i_{1,1,r} for each TRP), SD basis indicator indicating Lᵣ vector selection for each TRP r (e.g., one i_{1,2,r} indicating Lᵣ SD vectors for each TRP), and SCI (e.g., one i_{1,8,l} across TRPs).

In one example, G0 includes LI, and SD rotation factors indicating (q_{1,r}, q_{2,r}) each TRP r (e.g., one i_{1,1,r} for each TRP), SD basis indicator indicating Lᵣ beam selection for each TRP r (e.g., one i_{1,2,r} indicating Lᵣ SD vectors for each TRP), and one SCI for each TRP r (e.g., one i_{1,8,l,r} each TRP).

In one example, when CSI is reported, G0 includes CRI ordering indicator(s) indicating an order of CRIs (order of TRPs) with size of ┌log₂ N!┐ (or ┌log₂ n!┐, if n CSI RSs are selected).

In one example, when a TRP or CSI-RS resource indicator is reported, G0 includes reference CSI-RS indicator(s) (or strongest/reference TRP indicator) with the size of ┌log₂ N┐ (or ┌log₂ n┐, if n CSI RSs are selected).

In one example, G0 includes an indicator [symbol] regarding the number(s) of SD vectors Ly for r=1, . . . , N (e.g., when reporting Lᵣs corresponding to all configured TRPs (CSI-RS resources)).

In one example, the indicator [symbol] is a joint indicator or comprises separate indicators to indicate N values of (L₁, . . . , L_{N}).

In one example, the indicator [symbol] is a joint indicator or comprises separate indicators to indicate N−1 values of (L₁, . . . , L_{N-}). In this case, L_{N} can be determined based on (L₁, . . . , L_{N-}) and Lₛᵤₘ=Σᵣ₌₁^{N}Lᵣ, if Lₛᵤₘ is configured.

In one example, the indicator [symbol] is a joint indicator or comprises separate indicators to indicate N values of (L_{ϕ(1)}, . . . , L_{ϕ(N)}), where ϕ(·) is a permutation function, e.g., to reorder the TRP indices (CSI-RS resources) for reporting. For example, ϕ(·) can be determined based on CRI ordering in CSI Part 1.

In one example, the indicator [symbol] is a joint indicator or comprises separate indicators to indicate N−1 values of (L_{ϕ(1)}, . . . , L_{ϕ(N-1)}), where ϕ(·) is a permutation function, e.g., to reorder the TRP indices (CSI-RS resources) for reporting. For example, ϕ(·) can be determined based on CRI ordering in CSI Part 1. In this case, L_{ϕ(N)} can be determined based on (L_{ϕ(1)}, . . . , L_{ϕ(N-1)}) and Lₛᵤₘ=Σᵣ₌₁^{N}Lᵣ, if Lₛᵤₘ is configured.

In one example, G0 includes an indicator [symbol] regarding the number(s) of SD vectors Lᵣ for r∈S, where S is a subset of {1, . . . , N} (e.g., when reporting Lᵣs corresponding to a selected set of TRPs).

In one example, the indicator [symbol] is a joint indicator or comprises separate indicators to indicate |S| values of {Lₑ}_{r∈S}.

In one example, the indicator [symbol] is a joint indicator or comprises separate indicators to indicate |S|−1 values of {Lₑ}_{r∈S} excluding one Lᵣ, e.g., the Lᵣ corresponding to the last TRP index of r in S. In this case, the excluded Lᵣ can be determined based on [symbol] and Lₛᵤₘ=Σᵣ₌₁^{N}Lᵣ, if Lₛᵤₘ is configured.

In one example, the indicator [symbol] is a joint indicator or comprises separate indicators to indicate N values of {Lₑ}_{r∈S}, where ϕ(·) is a permutation function, e.g., to reorder the TRP indices (CSI-RS resources) for reporting. For example, ϕ(·) can be determined based on CRI ordering in CSI Part 1.

In one example, the indicator [symbol] is a joint indicator or comprises separate indicators to indicate N−1 values of {Lₑ}_{r∈S} excluding one L_{ϕ(r)}, e.g., the L_{ϕ(r)} corresponding to the last TRP index of r in S where ϕ(·) is a permutation function, e.g., to reorder the TRP indices (CSI-RS resources) for reporting. For example, ϕ(·) can be determined based on CRI ordering in CSI Part 1. In this case, the excluded L_{ϕ(r)} can be determined based on L and Lₛᵤₘ=Σᵣ₌₁^{N}Lᵣ, if Lₛᵤₘ is configured.

In one example, G0 includes an indicator [symbol] regarding the number(s) of SD vectors Lᵣ for r=1, . . . , N, where the indicator [symbol] is a joint indicator or comprises separate indicators to indicate 2 values of L̅₁ and L̅₂, where L̅₁ is L value for a first TRP-group of {1, . . . , N} and L̅₂ is L value for a second TRP-group of {1, . . . , N}. It can be according to at least one of the following examples.

In one example, the first group includes a strongest/reference TRP and the second group includes all TRPs excluding the strongest/reference TRP.

In one example, the first group includes two stronger TRPs and the second group includes all TRPs excluding the two stronger TRPs.

In one example, only when N >x, the example can be applied, where e.g., x=3 and/or 4 .

In one example, G0 includes an indicator [symbol] regarding the number(s) of SD vectors Lr for r E S, where the indicator [symbol] is a joint indicator or comprises separate indicators to indicate 2 values of L̅₁ and L̅₂, where L̅₁ is L value for a first TRP-group of S and L̅₂ is L value for a second TRP-group of S. It can be according to at least one of the following examples.

In one example, the first group includes a strongest/reference TRP and the second group includes all TRPs in S excluding the strongest/reference TRP.

In one example, the first group includes two stronger TRPs and the second group includes all TRPs in S excluding the two stronger TRPs.

In one example, only when N≥x, the example can be applied, where e.g., x=3 and/or 4 .

In one example, G0 includes any combination of indicators described in examples for CSI part 2, which may be explained below.

In one example, G0 includes any combination of indicators described in the above examples.

In one example, the CSI part 2 group 1 (G1) and group 2 (G2) comprise components according to at least one of the following examples (e.g., the case that amplitude, phase, and bitmap indicators are partitioned into two groups, similar to legacy (e.g., Rel-16 T2 CB)).

In one example: (1) G1 includes FD offset indicator (e.g., i_{1,5}), FD indicator indicating My (or M) vector selection (e.g., i_{1,6,l}), reference amplitude indicator (e.g., i_{2,3,l}), amplitude and phase indicators (e.g., i_{2,4,l}, i_{2,5,l}) of a first group A₁ of NZ coefficients, and bitmap indicator (e.g., i_{1,7,l}) for a first group B₁; and (2) G2 includes amplitude and phase indicators (e.g., i_{2,4,l}, i_{2,5,l}) of a second group A₂ of NZ coefficients, and bitmap indicator (e.g., i_{1,7,l}) for a second group B₂.

In one example: (1) G1 includes FD offset indicator (e.g., i_{1,5}), FD indicator indicating Mᵥ (or M) vector selection (e.g., i_{1,6,l}), reference amplitude indicator (e.g., i_{2,3,l}), amplitude and phase indicators (e.g., i_{2,4,l}, i_{2,5,l}) of a first group A₁ of NZ coefficients, and per-TRP bitmap indicator (e.g., i_{1,7,l,r}) for a first group B₁; and (2) G2 includes amplitude and phase indicators (e.g., i_{2,4,l}, i_{2,5,l}) of a second group A₂ of NZ coefficients, and per-TRP bitmap indicator (e.g., i_{1,7,l,r}) for a second group B₂.

In one example: (1) G1 includes FD offset indicator (e.g., i_{1,5}), FD indicator indicating Mᵥ (or M) vector selection (e.g., i_{1,6,l,}), reference amplitude indicator (e.g., i_{2,3,l}), per-TRP amplitude and phase indicators (e.g., i_{2,4,l,r}, i_{2,5,l,r}) of a first group A₁ of NZ coefficients, and bitmap indicator (e.g., i_{1,7,l}) for a first group B1; and (2) G2 includes per-TRP amplitude and phase indicators (e.g., i_{2,4,l,r}, i_{2,5,l,r}) of a second group A₂ of NZ coefficients, and bitmap indicator (e.g., i_{1,7,l}) for a second group B₂.

In one example: (1) G1 includes FD offset indicator (e.g., i_{1,5}), FD indicator indicating Mᵥ (or M) vector selection (e.g., i_{1,6,l}), reference amplitude indicator (e.g., i_{2,3,l}), per-TRP amplitude and phase indicators (e.g., i_{2,4,l,r}, i_{2,5,l,r}) of a first group A₁ of NZ coefficients, and per-TRP bitmap indicator (e.g., i_{1,7,l,r}) for a first group B1 and (2) G2 includes per-TRP amplitude and phase indicators (e.g., i_{2,4,l,r}, i_{2,5,l,r}) of a second group A₂ of NZ coefficients, and per-TRP bitmap indicator (e.g., i_{1,7,l}r) for a second group B₂.

In one example, for any of examples 1.1.2.1 - 1.1.2.4, instead of one FD offset indicator across TRPs, G1 includes FD offset indicator (e.g., i_{1,5,r}) for each of N TRPs.

In one example, this can be applied/used in Mode 1 only, i.e., only when Mode 1 is configured.

In one example, this can be applied/used in Mode 2 only, i.e., only when Mode 2 is configured.

In one example, this can be applied/used in both Mode 1 and Mode 2, i.e., either Mode 1 or Mode 2 is configured.

In one example (e.g., for examples as provided in the present disclosure), instead of one FD offset indicator across TRPs, G1 includes FD offset indicator (e.g., i_{1,5,r}) for each of N−1 TRPs (excluding a reference/strongest TRP).

In one example, this can be applied/used in Mode 1 only, i.e., only when Mode 1 is configured.

In one example, this can be applied/used in Mode 2 only, i.e., only when Mode 2 is configured.

In one example, this can be applied/used in both Mode 1 and Mode 2, i.e., either Mode 1 or Mode 2 is configured.

In one example (e.g., for examples as provided in the present disclosure), instead of one FD indicator indicating Mᵥ (or M) beam selection, G1 includes FD indicator indicating M_{v,r} (or Mᵣ) beam selection (e.g., i_{1,6,l,r}).

In one example, this can be applied/used in Mode 1 only, i.e., only when Mode 1 is configured.

In one example, this can be applied/used in Mode 2 only, i.e., only when Mode 2 is configured.

In one example, this can be applied/used in both Mode 1 and Mode 2, i.e., either Mode

1 or Mode 2 is configured.

The case that some other indicators in addition to amplitude, phase, and bitmap indicators are partitioned into two groups.

In one example: (1) G1 includes FD offset indicator (e.g., i_{1,5}), FD indicator indicating Mᵥ (or M) vector selection (e.g., i_{1,6,l}), reference amplitude indicator (e.g., i_{2,3,l}), amplitude and phase (e.g., i_{2,4,l}, i_{2,5,l}) of a first group A₁ of NZ coefficients, and bitmap indicator (e.g., i_{1,7,l}) for a first group B1; and (2) G2 includes amplitude and phase (e.g., i_{2,4,l}, i_{2,5,l}) of a second group A₂ of NZ coefficients, and bitmap indicator (e.g., i_{1,7,l}) for a second group B₂.

In one embodiment, FD offset indicator (e.g., i_{1,5} or i_{1,5,r}) and/or FD indicator indicating Mᵥ (or M) (M_{v,r} (or Mᵣ)) vector selection (e.g., i_{1,6,l} or i_{1,6,l,r}) are included in the CSI part 2 group 0 (G0), not in G1 described in any of the examples under example as provided in the present disclosure.

In one example, G0 includes FD offset indicator (e.g., i_{1,5}) in addition to any combination of indicators described in any of the examples under example as provided in the present disclosure For G1 and G2, at least one of the examples described under example as provided in the present disclosure can be applied, excluding FD offset indicator (e.g., i_{1,5}) in G1.

In one example, this can be applied/used in Mode 1 only, i.e., only when Mode 1 is configured.

In one example, this can be applied/used in Mode 2 only, i.e., only when Mode 2 is configured.

In one example, this can be applied/used in both Mode 1 and Mode 2, i.e., either Mode 1 or Mode 2 is configured.

In one example, G0 includes FD offset indicator (e.g., i_{1,5,r}) for each of N TRPs (or N−1 TRPs, excluding a reference/strongest TRP) in addition to any combination of indicators described in any of the examples under example as provided in the present disclosure. For G1 and G2, at least one of the examples described under example as provided in the present disclosure can be applied, excluding FD offset indicator (e.g., i_{1,5,r}) for each of N TRPs (or N−1 TRPs, excluding a reference/strongest TRP) in G1.

In one example, this can be applied/used in Mode 1 only, i.e., only when Mode 1 is configured.

In one example, this can be applied/used in Mode 2 only, i.e., only when Mode 2 is configured.

In one example, this can be applied/used in both Mode 1 and Mode 2, i.e., either Mode 1 or Mode 2 is configured.

In one example, G0 includes FD indicator indicating Mᵥ (or M) vector selection (e.g., i_{1,6,l}) in addition to any combination of indicators described in any of the examples under example as provided in the present disclosure For G1 and G2, at least one of the examples described under example as provided in the present disclosure can be applied, excluding FD indicator indicating Mᵥ (or M) vector selection (e.g., i_{1,6,l}) in G1.

In one example, this can be applied/used in Mode 1 only, i.e., only when Mode 1 is configured.

In one example, this can be applied/used in Mode 2 only, i.e., only when Mode 2 is configured.

In one example, this can be applied/used in both Mode 1 and Mode 2, i.e., either Mode 1 or Mode 2 is configured.

In example, G0 includes FD indicator indicating M_{v,r} (or Mᵣ) vector selection (e.g., i_{1,6,l,r}) in addition to any combination of indicators described in any of the examples under example as provided in the present disclosure. For G1 and G2, at least one of the examples described under example as provided in the present disclosure can be applied, excluding FD indicator indicating Mv.r (or MT) vector selection (e.g., i_{1,6,l,r}) in G1.

In one example, this can be applied/used in Mode 1 only, i.e., only when Mode 1 is configured.

In one example, this can be applied/used in Mode 2 only, i.e., only when Mode 2 is configured.

In one example, this can be applied/used in both Mode 1 and Mode 2, i.e., either Mode 1 or Mode 2 is configured.

In example, G0 includes FD offset indicator (e.g., i_{1,5}) and FD indicator indicating My (or M) vector selection (e.g., i_{1,6,l}) in addition to any combination of indicators described in any of the examples under example as provided in the present disclosure. For G1 and G2, at least one of the examples described under example as provided in the present disclosure can be applied, excluding FD offset indicator (e.g., i_{1,5}) and FD indicator indicating Mᵥ (or M) vector selection (e.g., i_{1,6,l}) in G1.

In one example, this can be applied/used in Mode 1 only, i.e., only when Mode 1 is configured.

In one example, this can be applied/used in Mode 2 only, i.e., only when Mode 2 is configured.

In one example, this can be applied/used in both Mode 1 and Mode 2, i.e., either Mode 1 or Mode 2 is configured.

In example, G0 includes FD offset indicator (e.g., i_{1,5,r}) for each of N TRPs (or N−1 TRPs, excluding a reference/strongest TRP) and FD indicator indicating Mᵥ (or M) vector selection (e.g., i_{1,6,l}) in addition to any combination of indicators described in any of the examples under example as provided in the present disclosure. For G1 and G2, at least one of the examples described under example as provided in the present disclosure can be applied, excluding FD offset indicator (e.g., i_{1,5,r}) for each of N TRPs (or N−1 TRPs, excluding a reference/strongest TRP) and FD indicator indicating Mᵥ (or M) vector selection (e.g., i_{1,6,l}) in G1.

In one example, this can be applied/used in Mode 1 only, i.e., only when Mode 1 is configured.

In one example, this can be applied/used in Mode 2 only, i.e., only when Mode 2 is configured.

In one example, this can be applied/used in both Mode 1 and Mode 2, i.e., either Mode 1 or Mode 2 is configured.

In one example, G0 includes FD offset indicator (e.g., i_{1,5}) and FD indicator indicating M_{v,r} (or Mᵣ) vector selection (e.g., i_{1,6,l,r}) in addition to any combination of indicators described in any of the examples under example as provided in the present disclosure. For G1 and G2, at least one of the examples described under example as provided in the present disclosure can be applied, excluding FD offset indicator (e.g., i_{1,5}) and FD indicator indicating M_{v,r} (or Mᵣ) vector selection (e.g., i_{1,6,l,r}) in G1.

In one example, this can be applied/used in Mode 1 only, i.e., only when Mode 1 is configured.

In one example, this can be applied/used in Mode 2 only, i.e., only when Mode 2 is configured.

In one example, this can be applied/used in both Mode 1 and Mode 2, i.e., either Mode 1 or Mode 2 is configured.

In one example, G0 includes FD offset indicator (e.g., i_{1,5}r) for each of N TRPs (or N−1 TRPs, excluding a reference/strongest TRP) and FD indicator indicating M_{v,r} (or Mᵣ) vector selection (e.g., i_{1,6,l,r}) in addition to any combination of indicators described in any of the examples under example as provided in the present disclosure. For G1 and G2, at least one of the examples described under example as provided in the present disclosure can be applied, excluding FD offset indicator (e.g., i_{1,5}r) for each of N TRPs (or N−1 TRPs, excluding a reference/strongest TRP) and FD indicator indicating M_{v,r} (or Mᵣ) vector selection (e.g., i_{1,6,l,r}) in G1.

In one example, this can be applied/used in Mode 1 only, i.e., only when Mode 1 is configured.

In one example, this can be applied/used in Mode 2 only, i.e., only when Mode 2 is configured.

In one example, this can be applied/used in both Mode 1 and Mode 2, i.e., either Mode 1 or Mode 2 is configured.

In one embodiment, only when a UE is configured to report CSI with “Mode1” wherein per-TRP SD vector selection and per-TRP FD vector selection are allowed (as shown in Mode 1 of embodiment 0), CSI part 2 can be designed according to at least one of examples as provided in the present disclosure for the CSI part 2 design.

In one embodiment, only when a UE is configured to report CSI with “Mode2” wherein per-TRP SD vector selection and TRP-common FD vector selection are allowed (as shown in Mode 2 of embodiment 0), CSI part 2 can be designed according to at least one of the following examples as provided in the present disclosure for CSI part 2 design.

In one example, when CSI reporting on PUSCH comprises two parts, the UE may omit a portion of the Part 2 CSI. Omission of Part 2 CSI is according to the priority order shown in 3GPP TS 38.214, where N_{Rep} is the number of CSI reports configured to be carried on the PUSCH. Priority 0 is the highest priority and priority 2N_{Rep} is the lowest priority and the CSI report n corresponds to the CSI report with the nth smallest Pri_{i.CSI}(y,k,c,s) value among the N_{Rep} CSI reports as defined in 3GPP TS 38.214.

The subbands for a given CSI report n indicated by the higher layer parameter csi-ReportingBand are numbered continuously in increasing order with the lowest subband of csi-ReportingBand as subband 0. When omitting Part 2 CSI information for a particular priority level, the UE may omit all of the information at that priority level.

For Enhanced Type II reports (Rel-16 Type-II CSI reporting), for a given CSI report n, each reported element of indices i_{2,4,l} i_{2,5,l} and i_{2,7,l}, indexed by l, i and f, is associated with a priority value Pri(l, i, f)=2·L·v·π(f)+v·i+1 , with π(f)=min(2·n_{3,l}^{(f)}, 2·(N₃−n_{3,l}^{(f)})−1) with l=1,2, . . . , v , i=0,1, . . . ,2L−1, and f=0,1, . . . , Mᵥ−1, and where n_{3,l}^{(f)} is defined in 3GPP standard specification. The element with the highest priority has the lowest associated value Pri(l, i, f). Omission of Part 2 CSI is according to the priority order shown in 3GPP TS 38.214, where: (1) Group 0 includes indices i_{1,1} (if reported), i_{1,2} (if reported) and i_{1,8,l} (l=1, . . . , v); (2) Group 1 includes indices i_{1,5} (if reported), i_{1,6,l} (if reported), the v2LMᵥ−└K^{NZ}/2┘ highest priority elements of i_{1,7,l}, i_{2,3,l} , the

$$max ( 0 , ⌈ \frac{{K}^{NZ}}{2} ⌉ - v )$$

highest priority elements of i_{2,4,l} and the

$$max ( 0 , ⌈ \frac{{K}^{NZ}}{2} ⌉ - v )$$

highest priority elements of i_{2,5,l} (l=1, . . . , v); and (3) Group 2 includes the └K^{NZ}/2┘ lowest priority elements of i_{2,7,l}, the

$$min ( {K}^{NZ} - v , ⌊ \frac{{K}^{NZ}}{2} ⌋ )$$

lowest priority elements of i_{2,4,l} and the

$$min ( {K}^{NZ} - v , ⌊ \frac{{K}^{NZ}}{2} ⌋ )$$

lowest priority elements of i_{2,5,l} (l=1, . . . , v).

For Further Enhanced Type II Port Selection reports, for a given CSI report n, each reported element of i_{2,4,l}, i_{2,5,l} and i_{2,7,l}, indexed by l, i and f , is associated with a priority value Pri(l, i, f)=K_{1·}v·f+v·i+l, with l=1,2, . . . , v, i=0,1, . . . , K₁−1 and f=0, . . . , M−1. The element with the highest priority has the lowest associated value Pri(l, i, f). Omission of Part 2 CSI is according to the priority order shown in 3GPP TS 38.214, where: (1) Group 0 includes i_{1,2} (if reported), i_{1,8,l} (l=1, . . . , v) and i_{1,6} (if reported); (2) Group 1 includes the UK₁M−└K^{NZ}/2┘ highest priority elements of i_{1,7,l} (if reported), i_{2,3,l}, the

$$max ( 0 , ⌈ \frac{{K}^{NZ}}{2} ⌉ - v )$$

highest priority elements of i_{2,4,l} and the

$$max ( 0 , ⌈ \frac{{K}^{N Z}}{2} ⌉ - υ )$$

highest priority elements of i_{2,5,l} (l=1, . . . , v); and (3) Group 2 includes the └K^{NZ}/2┘ lowest priority elements of i_{1,7,l} (if reported), the

$$min ( {K}^{N Z} - v , ⌊ \frac{{K}^{N Z}}{2} ⌋ )$$

lowest priority elements of i_{2,4,l} and the

$$min ( {K}^{N Z} - v , ⌊ \frac{{K}^{N Z}}{2} ⌋ )$$

lowest priority elements of i_{2,5,l} (l=1, . . . , v).

In one embodiment, the group partitioning for X₁ and X₂, where X∈{A, B, . . . } and A, B, . . . are described in embodiment 1.1, can be based on a priority rule, e.g., to determine two halves of the NZ coefficients (e.g., i_{2,4,l}, i_{2,5,l}) and/or NZ-coefficient bitmap (e.g., i_{1,7,l}). Each reported element of indices for component X are sorted or numbered according to at least one of the following schemes.

In one example, the priority rule can be as follows: (Layer→SD→FD) Each reported element of indices for component X indexed by l, i and f, is associated with a priority value Pri(l, i, f)=K_{1·}v·f+v·i+l, with π(·) is a permutation function. The element with the highest priority has the lowest associated value Pri(l, i, f). For index range, following examples can be provided.

In one example, l=1,2, . . . , v, i=0,1, . . . ,2L−1, and f=0,1, . . . , Mᵥ - 1.

In one example, l=1,2, . . . , v, i=0,1, . . . ,2L−1, and f=0,1, . . . , MYN - 1.

In one example, l=1,2, . . . , v, i=0,1, . . . ,2L−1, and f=0,1, . . . , Σᵣ₌^{N}M_{v,r}−1.

In one example, l=1,2, . . . , v, i=0,1, . . . ,2LN−1, and f=0,1, . . . , Mᵥ−1.

In one example, l=1,2, . . . , v, i=0,1, . . . ,2LN−1, and f=0,1, . . . , MᵥN −1.

In one example, l=1,2, . . . , u, i=0,1, . . . ,2LN−1, and f=0,1, . . . , Σᵣ₌^{N}M_{v,r}−1.

In one example, l=1,2, . . . , v, i=0,1, . . . ,2 Σᵣ₌^{N}Lᵣ−1, and f=0,1, . . . , Mᵥ−1.

In one example, l=1,2, . . . , u, i=0,1, . . . ,2 Σᵣ₌^{N}Lᵣ−1, and f=0,1, . . . , MᵥN −1.

In one example, (=1,2, . . . , v, i=0,1, . . . ,2 Σᵣ₌^{N}Lᵣ−1, and f=0,1, . . . , Σᵣ₌^{N}M_{v,r}−1.

For permutation function, following examples can be provided.

In one example, π(f)=f (e.g., no permutation).

In one example, π(f)=min(2·n_{3,l}^{(f)}, 2(N₃−n_{3,l}^{(f)})−1), where n_{3,l}^{(f)} is FD beam index defined in 3GPP TS 38.214.

In one example, π(f, r)=min(2·n_{3,l,r}^{(f)}, 2(N₃−n_{3,l,r}^{(f)})−1), where n_{3,l,r}^{(f)} is FD beam index for r=1, . . . , N.

In one example, π(f, r)=min(2·n_{3,l,r}^{(f)}−δ_{f,r}, 2(N₃−n_{3,l,r}^{(f)}+δ_{f,r})−1), where n_{3,l}^{(f)} is FD beam index for r=1, . . . , N and δ_{f,r} is relative FD offset index.

In one example, the priority rule can be as follows: (Layer→SD→FD) Each reported element of indices for component X indexed by l, i and f, is associated with a priority value Pri(l, i, f)=K_{1·}v·f+v·i+l, with π(·) is a permutation function. The element with the highest priority has the lowest associated value Pri(l, i, f).

For index range, following examples can be provided.

In one example, l=1,2, . . . , v, i=0,1, . . . ,2LN−1, and f=0,1, . . . , Mᵥ−1.

In one example, l=1,2, . . . , v, i=0,1, . . . ,2LN−1, and f=0,1, . . . , MᵥN −1.

In one example, l=1,2, . . . , v, i=0,1, . . . ,2LN−1, and f=0,1, . . . , Σᵣ₌^{N}M_{v,r}−1.

For permutation function, following examples can be provided.

In one example, π(f)=f (e.g., no permutation).

In one example, π(f)=min(2·n_{3,l}^{(f)}, 2(N₃−n_{3,l}^{(f) l )-}1), where n_{3,l}^{(f)} is FD beam index defined in 3GPP TS 38.214.

In one example, π(f, r)=min(2·n_{3,l,r}^{(f)}, 2(N₃−n_{3,l,r}^{(f)})−1), where n_{3,l,r}^{(f)} is FD beam index for r=1, . . . , N.

In one example, π(f, r)=min(2·n_{3,l,r}^{(f)}−δ_{f,r}, 2(N₃−n_{3,l,r}^{(f)}+δ_{f,r})−1), where n_{3,l}^{(f)} is FD beam index and δ_{f,r} is relative FD offset index for r=1, . . . , N.

In one example, the priority rule can be as follows: (Layer→SD→FD) Each reported element of indices for component X indexed by l, i and f, is associated with a priority value Pri(l, i, f)=K_{1·}v·f+v·i+l, with π(·) is a permutation function. The element with the highest priority has the lowest associated value Pri(l, i, f).

For index range, following examples can be provided.

In one example, l=1,2, . . . , v, i=0,1, . . . , Σᵣ₌₁^{N}2Lᵣ−1, and f=0,1, . . . , Mᵥ−1.

In one example, l=1,2, . . . , v, i=0,1, . . . , Σᵣ₌₁^{N}2Lᵣ−1, and f=0,1, . . . , MᵥN −1.

In one example, l=1,2, . . . , u, i=0,1, . . . , Σᵣ₌₁^{N}2Lᵣ−1, and f=0,1, . . . , Σᵣ₌^{N}M_{v,r}−1.

For permutation function, following examples can be provided.

In one example, π(f)=f (e.g., no permutation).

In one example, π(f)=min(2·n_{3,l}^{(f)}, 2(N₃−n_{3,l}^{(f) l )-}1), where n_{3,l}^{(f)} is FD beam index defined in 3GPP TS 38.214.

In one example, π(f, r)=min(2·n_{3,l,r}^{(f)}, 2(N₃−n_{3,l,r}^{(f)})−1), where n_{3,l,r}^{(f)} is FD beam index for r=1, . . . , N.

In one example, π(f, r)=min(2·n_{3,l,r}^{(f)}−δ_{f,r}, 2(N₃−n_{3,l,r}^{(f)}+δ_{f,r})−1), where n_{3,l}^{(f)} is FD beam index and δ_{f,r} is relative FD offset index for r=1, . . . , N.

In one example, the priority rule can be as follows: (Layer→SD→FD) Each reported element of indices for component X indexed by l, i and f, is associated with a priority value Pri(l, i, f)=K_{1·}v·f+v·i+l, with π(·) is a permutation function. The element with the highest priority has the lowest associated value Pri(l, i, f).

For index range, following examples can be provided.

In one example, l=1,2, . . . , UN, i=0,1, . . . ,2L−1, and f=0,1, . . . , Mᵥ−1.

In one example, l=1,2, . . . , UN, i=0,1, . . . ,2L−1, and f=0,1, . . . , Σᵣ₌^{N}M_{v,r}−1.

In one example, the priority rule can be as follows: (Layer→SD→FD) Each reported element of indices for component X indexed by l, i and f, is associated with a priority value Pri(l, i, f)=K_{1·}v·f+v·i+l, with π(·) is a permutation function. The element with the highest priority has the lowest associated value Pri(l, i, f).

For index range, following examples can be provided.

In one example, l=1,2, . . . , UN, i=0,1, . . . , Σᵣ₌₁^{N}2Lᵣ−1, and f=0,1, . . . , Mᵥ−1.

In one example, (=1,2, . . . , UN , i=0,1, . . . , Σᵣ₌₁^{N}2Lᵣ−1, and f=0,1, . . . , Σᵣ₌^{N}M_{v,r}−1.

In one example, the priority rule can be as follows: (Layer→SD→FD→TRP) Each reported element of indices for component X indexed by l, i, f, and r, is associated with a priority value Pri(l, i, f, r)=2·L·v·Σₙ₌₁^{r} M_{v,n}+2·L·v·π(·)+v·i+l, with π(·) is a permutation function, where l=1,2, . . . , v, i=0,1, . . . ,2L−1, f=0,1, . . . , Mᵥ−1, and r=1, . . . , N. The element with the highest priority has the lowest associated value Pri(l, i, f, r).

In one example, π(f)=f (e.g., no permutation).

In one example, π(f)=min(2·n_{3,l}^{(f)}, 2(N₃−n_{3,l}^{(f) l )-}1, where n_{3,l}^{(f)} is defined in 3GPP TS 38.214.

In one example, π(f, r)=min(2·n_{3,l,r}^{(f)}, 2(N₃−n_{3,l,r}^{(f)})−1), n_{3,l}^{(f)} is defined similar to 3GPP TS 38.214.

In one example, π(f, r)=min(2·n_{3,l,r}^{(f)}−δ_{f,r}, 2(N₃−n_{3,l,r}^{(f)}+δ_{f,r})−1), where n_{3,l}^{(f)} FD beam index and δ_{f,r} is relative FD offset index for r=1, . . . , N.

In one example, the priority rule is the same as example as provided in the present disclosure except Pri(l, i, f, r), which is given by Pri(l, i, f)=K_{1·}v·f+v·i+l,

In one example, the priority rule can be as follows: (Layer→SD→FD→TRP) Each reported element of indices for component X indexed by l, i, f, and r, is associated with a priority value Pri(l, i, f, r)=2·L·v·Σₙ₌₁^{r} M_{v,n}+2·L·v·π(·)+v·i+l, with π(·) is a permutation function, where l=1,2, . . . , v, i=0,1, . . . ,2L−1, f=0,1, . . . , M_{v,r}−1, and r=1, . . . , N. The element with the highest priority has the lowest associated value Pri(l, i, f, r).

In one example, x(f)=f (e.g., no permutation).

In one example, π(f)=min(2·n_{3,l}^{(f)}, 2(N₃−n_{3,l}^{(f) l )-}1, where n_{3,l}^{(f)} is defined in 3GPP TS 38.214.

In one example, π(f, r)=min(2·n_{3,l,r}^{(f)}, 2(N₃−n_{3,l,r}^{(f)})−1), n_{3,l}^{(f)} is defined similar to 3GPP TS 38.214.

In one example, π(f, r)=min(2·n_{3,l,r}^{(f)}−δ_{f,r}, 2(N₃−n_{3,l,r}^{(f)}+δ_{f,r})−1), where n_{3,l}^{(f)} FD beam index and δ_{f,r} is relative FD offset index for r=1, . . . , N.

In one example, the priority rule is the same as example as provided in the present disclosure except Pri(l, i, f , r), which is given by Pri(l, i, f, r)=2·L·v·Σₙ₌₁^{r} M_{v,n}+2·L·v·π(·)+v·i+l.

In one example, the priority rule can be as follows: (Layer→SD→FD→TRP) Each reported element of indices for component X indexed by l, i, f, and r, is associated with a priority value Pri(l, i, f, r)=2·L·v·Σₙ₌₁^{r} M_{v,n}+2·L·v·π(·)+v·i+l, with π(·) is a permutation function, where l=1,2, . . . , v, i=0,1, . . . ,2Lᵣ−1, f=0,1, . . . , Mᵥ - 1, and r=1, . . . , N. The element with the highest priority has the lowest associated value Pri(l, i, f, r).

In one example, x(f)=f (e.g., no permutation).

In one example, π(f)=min(2·n_{3,l}^{(f)}, 2(N₃−n_{3,l}^{(f) l )-}1, where n_{3,l}^{(f)} is defined in 3GPP TS 38.214.

In one example, π(f, r)=min(2·n_{3,l,r}^{(f)}, 2(N₃−n_{3,l,r}^{(f)})−1), n_{3,l}^{(f)} is defined similar to 3GPP TS 38.214.

In one example, π(f, r)=min(2·n_{3,l,r}^{(f)}−δ_{f,r}, 2(N₃−n_{3,l,r}^{(f)}+δ_{f,r})−1), where n_{3,l}^{(f)} FD beam index and δ_{f,r} is relative FD offset index for r=1, . . . , N.

In one example, the priority rule is the same as example as provided in the present disclosure except that Pri(l, i, f, r) is given by Pri(l, i, f, r)=2·L·v·Σₙ₌₁^{r} M_{v,n}+2·L·v·π(·)+v·i+l.

In one example, the priority rule can be as follows: (Layer→SD→FD→TRP) Each reported element of indices for component X indexed by l, i, f, and r, is associated with a priority value Pri(l, i, f, r)=2·L·v·Σₙ₌₁^{r} M_{v,n}+2·L·v·π(·)+v·i+l, with π(·) is a permutation function, where l=1,2, . . . , v, i=0,1, . . . ,2Lᵣ−1, f=0,1, . . . , M_{v,r}−1, and r=1, . . . , N. The element with the highest priority has the lowest associated value Pri(l, i, f, r).

In one example, x(f)=f (e.g., no permutation).

In one example, π(f)=min(2·n_{3,l}^{(f)}, 2(N₃−n_{3,l}^{(f) l )-}1, where n_{3,l}^{(f)} is defined in 3GPP TS 38.214.

In one example, π(f, r)=min(2·n_{3,l,r}^{(f)}, 2(N₃−n_{3,l,r}^{(f)})−1), n_{3,l}^{(f)} is defined similar to 3GPP TS 38.214.

In one example, π(f, r)=min(2·n_{3,l,r}^{(f)}−δ_{f,r}, 2(N₃−n_{3,l,r}^{(f)}+δ_{f,r})−1), where n_{3,l}^{(f)} FD beam index and δ_{f,r} is relative FD offset index for r=1, . . . , N.

In one example, the priority rule is the same as example as provided in the present disclosure except that Pri(l, i, f, r) is given by Pri(l, i, f, r)=2·L·v·Σₙ₌₁^{r} M_{v,n}+2·L·v·π(·)+v·i+l.

In one example, the priority rule can be as follows: (Layer→SD→TRP→FD) Each reported element of indices for component X indexed by l, i, f, and r, is associated with a priority value Pri(l, i, f, r)=2·L·v·Σₙ₌₁^{r} M_{v,n}+2·L·v·π(·)+v·i+l, with π(·) is a permutation function, where l=1,2, . . . , v, i=0,1, . . . ,2L−1, f=0,1, . . . , Mᵥ - 1 (or f=0,1, . . . , M_{v,r} - 1), and r=1, . . . , N . The element with the highest priority has the lowest associated value Pri(l, i, f, r).

In one example, x(f)=f (e.g., no permutation).

In one example, π(f)=min(2·n_{3,l}^{(f)}, 2(N₃−n_{3,l}^{(f) l )-}1, where n_{3,l}^{(f)} is defined in 3GPP TS 38.214.

In one example, π(f, r)=min(2·n_{3,l,r}^{(f)}, 2(N₃−n_{3,l,r}^{(f)})−1), n_{3,l}^{(f)} is defined similar to 3GPP TS 38.214.

In one example, π(f, r)=min(2·n_{3,l,r}^{(f)}−δ_{f,r}, 2(N₃−n_{3,l,r}^{(f)}+δ_{f,r})−1), where n_{3,l}^{(f)} FD beam index and δ_{f,r} is relative FD offset index for r=1, . . . , N.

In one example, the priority rule is the same as example as provided in the present disclosure except that Pri(l, i, f, r) is given by Pri(l, i, f, r)=2·L·v·Σₙ₌₁^{r} M_{v,n}+2·L·v·π(·)+v·i+l.

In one example, the priority rule can be as follows: (Layer >SD→TRP >FD) Each reported element of indices for component X indexed by l, i, f, and r, is associated with a priority value Pri(l, i, f, r)=2·L·v·Σₙ₌₁^{r} M_{v,n}+2·L·v·π(·)+v·i+l, with w(·) is a permutation function, where l=1,2, . . . , v, i=0,1, . . . ,2Lᵣ−1, f=0,1, . . . , Mᵥ−1 (or f=0,1, . . . , M_{v,r}−1 ), and r=1, . . . , N. The element with the highest priority has the lowest associated value Pri(l, i, f, r).

In one example, x(f)=f (e.g., no permutation).

In one example, π(f)=min(2·n_{3,l}^{(f)}, 2(N₃−n_{3,l}^{(f) l )-}1, where n_{3,l}^{(f)} is defined in 3GPP TS 38.214.

In one example, π(f, r)=min(2·n_{3,l,r}^{(f)}, 2(N₃−n_{3,l,r}^{(f)})−1), n_{3,l}^{(f)} is defined similar to 3GPP TS 38.214.

In one example, π(f, r)=min(2·n_{3,l,r}^{(f)}−δ_{f,r}, 2(N₃−n_{3,l,r}^{(f)}+δ_{f,r})−1), where n_{3,l}^{(f)} FD beam index and δ_{f,r} is relative FD offset index for r=1, . . . , N.

In one example, the priority rule is the same as example as provided in the present disclosure except that Pri(l, i, f, r) is given by Pri(l, i, f, r)=2·L·v·Σₙ₌₁^{r} M_{v,n}+2·L·v·π(·)+v·i+l.

In one example, the priority rule can be as follows: (Layer→TRP >SD→FD) Each reported element of indices for component X indexed by l, i, f, and r, is associated with a priority value Pri(l, i, f, r)=2·L·v·N·π(·)+v·N·i+v·(r−1)+l, with π(·) is a permutation function, where l=1,2, . . . , v, i=0,1, . . . ,2L−1, f=0,1, . . . , Mᵥ−1 (or f=0,1, . . . , M_{v,r} - 1), and r=1, . . . , N . The element with the highest priority has the lowest associated value Pri(l, i, f, r).

In one example, x(f)=f (e.g., no permutation).

In one example, π(f)=min(2·n_{3,l}^{(f)}, 2(N₃−n_{3,l}^{(f) l )-}1, where n_{3,l}^{(f)} is defined in 3GPP TS 38.214.

In one example, π(f, r)=min(2·n_{3,l,r}^{(f)}, 2(N₃−n_{3,l,r}^{(f)})−1), n_{3,l}^{(f)} is defined similar to 3GPP TS 38.214.

In one example, π(f, r)=min(2·n_{3,l,r}^{(f)}−δ_{f,r}, 2(N₃−n_{3,l,r}^{(f)}+δ_{f,r})−1), where n_{3,l}^{(f)} FD beam index and δ_{f,r} is relative FD offset index for r=1, . . . , N.

In one example, the priority rule is the same as example as provided in the present disclosure except that Pri(l, i, f, r) is given by Pri(l, i, f, r)=2·L·v·N·π(·)+u·N·i+U·r+l.

In one example, the priority rule can be as follows: (Layer >TRP >SD→FD) Each reported element of indices for component X indexed by l, i, f, and r, is associated with a priority value Pri(l, i, f, r)=2·L·v·N·π(·)+v·N·i+v·(r−1)+l, with π(·) is a permutation function, where l=1,2, . . . , v, i=0,1, . . . ,2Lᵣ−1, f=0,1, . . . , Mᵥ−1 (or f=0,1, . . . , M_{v,r} - 1), and r=1, . . . , N . The element with the highest priority has the lowest associated value Pri(l, i, f, r).

In one example, x(f)=f (e.g., no permutation).

In one example, π(f)=min(2·n_{3,l}^{(f)}, 2(N₃−n_{3,l}^{(f) l )-}1, where n_{3,l}^{(f)} is defined in 3GPP TS 38.214.

In one example, π(f, r)=min(2·n_{3,l,r}^{(f)}, 2(N₃−n_{3,l,r}^{(f)})−1), n_{3,l}^{(f)} is defined similar to 3GPP TS 38.214.

In one example, π(f, r)=min(2·n_{3,l,r}^{(f)}−δ_{f,r}, 2(N₃−n_{3,l,r}^{(f)}+δ_{f,r})−1), where n_{3,l}^{(f)} FD beam index and δ_{f,r} is relative FD offset index for r=1, . . . , N.

In one example, the priority rule is the same as example as provided in the present disclosure except that Pri(l, i, f, r) is given by Pri(l, i, f, r)=2·L·v·N·π(·)+u·N·i+v·r+l.

In one example, the priority rule is the same as example as provided in the present disclosure except that Pri(l, i, f, r) is given by Pri(l, i, f, r)=2·L·v·N·π(·)+u·N·i+v·r+l, where L*=max({Ln}n=1) or L′ is determined by one of the values L₁, . . . , L_{N}.

In one example, the priority rule is the same as example as provided in the present disclosure except that Pri(l, i, f, r) is given by Pri(l, i, f, r)=2·L·v·N·π(·)+u·N·i+v·r+l, where L*=max({Ln}=1) or L′ is determined by one of the values L₁, . . . , L_{N}.

In one example, the priority rule is the same as example as provided in the present disclosure except that Pri(l, i, f, r) is given by Pri(l, i, f , r)=2·Σₙ₌₁^{N}Lₙ·v·N·π(·)+v·N·i+v·(r−1)+l.

In one example, the priority rule is the same as example as provided in the present disclosure except that Pri(l, i, f, r) is given by Pri(l, i, f , r)=2·Σₙ₌₁^{N}Lₙ·v·N·π(·)+v·N·i+v·(r−1)+l.

In one example, the priority rule can be as follows: (TRP→Layer→SD→FD) Each reported element of indices for component X indexed by l, i, f, and r, is associated with a priority value Pri(l, i, f, r)=2·L·v·N·π(·)+v·N·i+N·l+r , with π(·) is a permutation function, where l=1,2, . . . , v, i=0,1, . . . ,2L−1, f=0,1, . . . , Mᵥ−1 (or f=0,1, . . . , M_{v,r}−1), and r=1, . . . , N. The element with the highest priority has the lowest associated value Pri(l, i, f, r).

In one example, x(f)=f (e.g., no permutation).

In one example, π(f)=min(2·n_{3,l}^{(f)}, 2(N₃−n_{3,l}^{(f) l )-}1, where n_{3,l}^{(f)} is defined in 3GPP TS 38.214.

In one example, π(f, r)=min(2·n_{3,l,r}^{(f)}, 2(N₃−n_{3,l,r}^{(f)})−1), n_{3,l}^{(f)} is defined similar to 3GPP TS 38.214.

In one example, π(f, r)=min(2·n_{3,l,r}^{(f)}−δ_{f,r}, 2(N₃−n_{3,l,r}^{(f)}+δ_{f,r})−1), where n_{3,l}^{(f)} FD beam index and δ_{f,r} is relative FD offset index for r=1, . . . , N.

In one example, the priority rule is the same as example as provided in the present disclosure except Pri(l, i, f, r), which is given by Pri(l, i, f, r)=2·L·v·N·π(·)+v·N·i+N·l+r .

In one example, the priority rule can be as follows: (TRP→Layer→SD→FD) Each reported element of indices for component X indexed by l, i, f, and r, is associated with a priority value Pri(l, i, f, r)=2·L·v·N·π(·)+v·N·i+N·l+r , with π(·) is a permutation function, where l=1,2, . . . , v, i=0,1, . . . ,2L−1, f=0,1, . . . , Mᵥ−1 (or f=0,1, . . . , M_{v,r}−1),function, where l=1,2, . . . , v, i=0,1, . . . ,2L−1, f=0,1, . . . , Mᵥ−1 (or f=0,1, . . . , M_{v,r}−1), and r=1, . . . , N. The element with the highest priority has the lowest associated value Pri(l, i, f, r).

In one example, «(f)=f (e.g., no permutation).

In one example, π(f)=min(2·n_{3,l}^{(f)}, 2(N₃−n_{3,l}^{(f) l )-}1, where n_{3,l}^{(f)} is defined in 3GPP TS 38.214.

In one example, π(f, r)=min(2·n_{3,l,r}^{(f)}, 2(N₃−n_{3,l,r}^{(f)})−1), n_{3,l}^{(f)} is defined similar to 3GPP TS 38.214.

In one example, π(f, r)=min(2·n_{3,l,r}^{(f)}−δ_{f,r}, 2(N₃−n_{3,l,r}^{(f)}+δ_{f,r})−1), where n_{3,l}^{(f)} FD beam index and δ_{f,r} is relative FD offset index for r=1, . . . , N.

In one example, the priority rule is the same as example as provided in the present disclosure except Pri(l, i, f, r), which is given by Pri(l, i, f, r)=2·Lᵣ·v·N·π(·)+v·N·i+N·l +(r−1).

In one example, the priority rule is the same as example as provided in the present disclosure except Pri(l, i, f, r), which is given by Pri(l, i, f, r)=2·L*·v·N·π(·)+v·N·i+N·l +r, where L*=max({Ln}N=1) or L′ is determined by one of the values L₁, . . . , L_{N}.

In one example, the priority rule is the same as example as provided in the present disclosure except Pri(l, i, f, r), which is given by Pri(l, i, f, r)=2·L*·v·N·π(·)+v·N·i+N·l +(r−1), where L*=max({Ln}N=1) or L* is determined by one of the values L₁, . . . , L_{N}.

In one example, the priority rule is the same as example as provided in the present disclosure except Pri(l, i, f, r), which is given by Pri(l, i, f , r)=2·Σₙ₌₁^{N}Lₙ·V·N·π(·)+v·N·i+N·l+r.

In one example, the priority rule is the same as example as provided in the present disclosure except Pri(l, i, f, r), which is given by Pri(l, i, f, r)=2·Σₙ₌₁^{N}Lₙ·V·N·π(·)+v·N·i+N·l+(r−1).

In one example, Mᵥ described in any example of this disclosure can be replaced by M, i.e., which is not dependent of rank v.

In one example, TRP index (or CSI-RS resource index) r described in any example of this disclosure can start from 0 to N−1, i.e., r=0, . . ., N−1, (or r=1, . . . , N).

In one example, TRP index (or CSI-RS resource index) r described in any example of this disclosure can be based on an order of CRIs (e.g., determined and reported by UE via CSI part 1).

In one example, TRP index (or CSI-RS resource index) r described in any example of this disclosure can be based on configured CSI-RS resource numbers.

In one example, TRP index (or CSI-RS resource index) r described in any example of this disclosure can be based on a subset of TRP indexes (e.g., a case of TRP selection determined and reported by UE via CSI part 1).

In one example, TRP index (or CSI-RS resource index) r described in any example of this disclosure can start from the TRP associated with the SCI (strongest coefficient indicator).

In one example, TRP index (or CSI-RS resource index) r described in any example of this disclosure can be shifted with respect to the TRP associated with the SCI (strongest coefficient indicator).

In one example, L described in any example of this disclosure can be replaced by Lᵣ, Lₜₒₜ, L*, and its index (i) counting limit is changed according to the replaced value, where Lₜₒₜ=Σₙ₌₁^{N}Lₙ, L*=max({Lₙ}ₙ₌₁^{N}) or L* is determined by one of the values L₁, . . . , L_{N}.

In one example, permutation function π(·) can be defined by at least one of the following examples.

In one example, π(f)=f (e.g., no permutation).

In one example, π(f)=min(2·n_{3,l}^{(f)}, 2(N₃−n_{3,l}^{(f) l )-}1, where n_{3,l}^{(f)} is defined in 3GPP TS 38.214.

In one example, π(f, r)=min(2·n_{3,l,r}^{(f)}, 2(N₃−n_{3,l,r}^{(f)})−1), n_{3,l}^{(f)} is defined similar to 3GPP TS 38.214.

In one example, π(f, r)=min(2·n_{3,l,r}^{(f)}−δ_{f,r}, 2(N₃−n_{3,l,r}^{(f)}+δ_{f,r})−1), where n_{3,l}^{(f)} FD beam index and δ_{f,r} is relative FD offset index for r=1, . . . , N.

In one example, permutation function π(·) can be applied/utilized according to at least one of the following examples.

In one example, permutation function π(·) can be applied/used in Mode 1 only, i.e., only when Mode 1 is configured. In this case, a priority-rule function is with permutation function Tt(·) only when Mode 1 is configured, where the priority-rule function can be one of the examples as provided in the present disclosure.

In one example, permutation function π(·) can be applied/used in Mode 2 only, i.e., only when Mode 2 is configured. In this case, a priority-rule function is with permutation function Tt(·) only when Mode 2 is configured, where the priority-rule function can be one of the examples in embodiment as provided in the present disclosure.

In one example, permutation function π(·) can be applied/used in both Mode 1 and Mode 2, i.e., when either Mode 1 or Mode 2 is configured. In this case, a priority-rule function is with permutation function π(·) for both Mode 1 and Mode 2, where the priority-rule function can be one of the examples in embodiment as provided in the present disclosure.

In one example, permutation function π(·) can be applied/used for one TRP (e.g., reference TRP or strongest TRP), and no permutation function π(·) can be applied/used for remaining N−1 TRPs. In this case, a priority-rule function is with permutation function It (·) only for a reference TRP, where the priority-rule function can be one of the examples in embodiment as provided in the present disclosure.

In one example, permutation function π(·) can be applied/used for one TRP (e.g., reference TRP or strongest TRP), and no permutation function (·) can be applied/used for remaining N−1 TRPs, only when Mode 1 is configured. In this case, a priority-rule function is with permutation function π(·) only for a reference TRP only when Mode 1 is configured, where the priority-rule function can be one of the examples in embodiment as provided in the present disclosure.

In one example, permutation function π(·) can be applied/used for one TRP (e.g., reference TRP or strongest TRP), and no permutation function π(·) can be applied/used for remaining N−1 TRPs, only when Mode 2 is configured. In this case, a priority-rule function is with permutation function π(·) only for a reference TRP only when Mode 2 is configured, where the priority-rule function can be one of the examples in embodiment as provided in the present disclosure.

In one example, permutation function π(·) can be applied/used for one TRP (e.g., reference TRP or strongest TRP), and no permutation function π(·) can be applied/used for remaining N−1 TRPs, when either Mode 1 or Mode 2 is configured. In this case, a priority-rule function is with permutation function π(·) only for a reference TRP when either Mode 1 or Mode 2 is configured, where the priority-rule function can be one of the examples in embodiment as provided in the present disclosure.

In one example, utilizing/applying permutation function π(·) in a priority-rule function can be configurable via RRC, MAC-CE, or DCI. For example, if configured, the function is applied (ON). Otherwise, the function is not applied (OFF).

In one example, utilizing/applying permutation function π(·) in a priority-rule function can be determined by UE and reported by UE via CSI part 1.

In one example, utilizing/applying permutation function π(·) in a priority-rule function can be determined by UE and reported by UE via CSI part 2.

In one embodiment, when CSI reporting on PUSCH (or, optionally on PUCCH) comprises two parts, Part 1 CSI and Part 2 CSI, the UE may omit (hence does not report) a portion of the Part 2 CSI. Omission of Part 2 CSI is according to the priority order shown in TABLE 6 or TABLE 7, where N_{Rep} is the number of CSI reports configured to be carried on the PUSCH. Priority 0 is the highest priority and priority 2N_{Rep} is the lowest priority and the CSI report n corresponds to the CSI report with the nth smallest Pri_{i.CSI}(y,k,c,s) value among the N_{Rep} CSI reports as defined in 3GPP TS 38,214, which is copied below.

CSI reports are associated with a priority value Pri_{i.CSI}(y,k,c,s)=2·N_{cells}·Mₛ·y+N_{cells}·Mₛ·k+Mₛ·c+s where: (1) y=0 for aperiodic CSI reports to be carried on PUSCH y32 1 for semi-persistent CSI reports to be carried on PUSCH, y=2 for semi-persistent CSI reports to be carried on PUCCH and y32 3 for periodic CSI reports to be carried on PUCCH; k=0 for CSI reports carrying L1-RSRP and K=1 for CSI reports not carrying L1-RSRP; c is the serving cell index and N_{cells} is the value of the higher layer parameter maxNrofServingCells; and s is the reportConfigID and Mₛ is the value of the higher layer parameter maxNrofCSI-ReportConfigurations.

A first CSI report is said to have priority over second CSI report if the associated Pri_{i.CSI}(v,k,c,s) value is lower for the first report than for the second report.

The subbands for a given CSI report n indicated by the higher layer parameter csi-ReportingBand are numbered continuously in increasing order with the lowest subband of csi-ReportingBand as subband 0. When omitting Part 2 CSI information for a particular priority level, the UE may omit all of the information at that priority level.

TABLE 6
Priority reporting levels for Part 2 CSI

Priority 0: Part 2 wideband CSI for CSI reports 1 to N_{Rep}
Priority 1: Part 2 subband CSI of G₁ for CSI report 1
Priority 2: Part 2 subband CSI of G₂ for CSI report 1
Priority 3: Part 2 subband CSI of G₁ for CSI report 2
Priority 4: Part 2 subband CSI of G₂ for CSI report 2
.
.
.
Priority 2N_{Rep} − 1: Part 2 subband CSI of G₁ for CSI report N_{Rep}
Priority 2N_{Rep}: Part 2 subband CSI of G₂ for CSI report N_{Rep}

In TABLE 6, G₁=the first group, and G₂=the second group, as provided in this disclosure, if the CSI report is configured to be according to the PD compression framework; and G₁=even subbands, and G₂=odd subbands; otherwise (if the CSI report is configured to comprise subband CSI for each subband independently, i.e., without any FD compression).

TABLE 7
Priority reporting levels for Part 2 CSI

Priority 0: Part 2 G0 CSI for CSI reports 1 to N_{Rep}
Priority 1: Part 2 subband CSI of G₁ for CSI report 1
Priority 2: Part 2 subband CSI of G₂ for CSI report 1
Priority 3: Part 2 subband CSI of G₁ for CSI report 2
Priority 4: Part 2 subband CSI of G₂ for CSI report 2
.
.
.
Priority 2N_{Rep} − 1: Part 2 subband CSI of G₁ for CSI report N_{Rep}
Priority 2N_{Rep}: Part 2 subband CSI of G₂ for CSI report N_{Rep}

In TABLE 7, G₀=the first group, G₁=the second group, and G₂=the third group, as provided in this disclosure, if the CSI report is configured to be according to the FD compression framework; and G₀=wideband, G₁=even subbands, and G₂=odd subbands; otherwise (if the CSI report is configured to comprise subband CSI for each subband independently, i.e., without any FD compression).

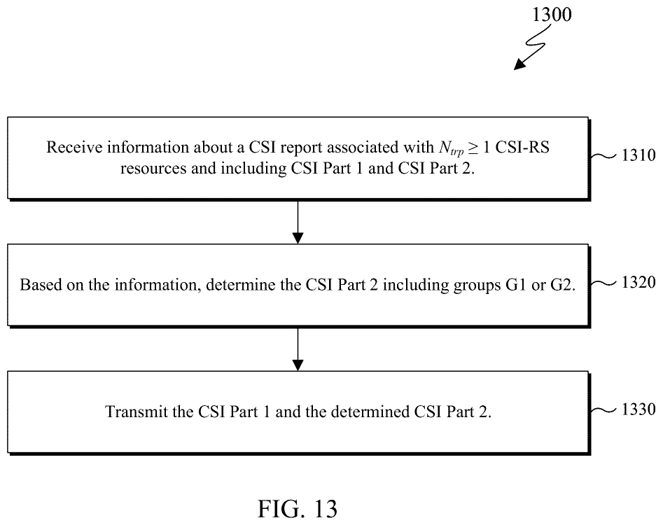

FIG. 13 illustrates an example method 1300 performed by a UE in a wireless communication system according to embodiments of the present disclosure. The method 1300 of FIG. 13 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1300 is for illustration only and other embodiments can be used without departing from the scope of the present disclosure.

The method begins with the UE receiving information about a CSI report associated with Nₜᵣₚ≥1 CSI reference signal CSI-RS resources and including a CSI Part 1 and a CSI Part 2 (1310). In various embodiments, the information includes information to include an indicator, in a group G0, to indicate a FD offset value for each of (N−1) CSI-RS resources. In various embodiments, the CSI Part 1 includes a channel quality indicator (CQI), a rank indicator (RI), and a total number of non-zero coefficients (NZC) KNZ across all v layers and N CSI-RS resources. In various embodiments, the CSI Part 2 further includes a group G0 and the group G0 includes: an indicator of i_{1,1} indicating SD rotation factors (q_{1,r}, q_{2,r}) for each CSI-RS resource r, an indicator of i_{1,2} indicating Lᵣ SD basis selection for each CSI-RS resource r, and a strongest coefficient indicator of i_{1,8,l} across all N CSI-RS resources for each layer l=1, . . . , v.

The UE then, based on the information, determines the CSI Part 2 including groups G1 or G2 (1320). For example, in 1320, an amplitude coefficient indicator and a phase coefficient indicator are included in G1 or G2 based on a priority value Pri(l, i, f, r)=2·Σₙ₌₁^{N}L_{ϕ(n)}·v·π(f)+2·v·Σₙ₌₁^{r-1}L_{ϕ(n)}+v·i+l. In various embodiments, the permutation function π(f) corresponds to π(f)=min(2·n_{3,l}^{(f)},2·(N₃−n_{3,l}^{(f)})−1), where n_{3,l}^{(f)} is a FD basis vector index, and N₃ is a number of precoding matrices.

In various embodiments, the group G1 includes v2ΣᵣLᵣMᵥ−└K^{NZ}/2┘ highest priority elements of i_{1,7,l},

$$max ( 0 , ⌈ \frac{{K}^{N Z}}{2} ⌉ - υ ) ,$$

highest priority elements of i_{2,4,l}, and

$$max ( 0 , ⌈ \frac{{K}^{N Z}}{2} ⌉ - υ )$$

highest priority elements of i_{2,5,l} (l=1, . . . , v), where i_{2,4,l} and i_{2,5,l} are indicators to indicate amplitudes and phases of non-zero coefficients, i_{1,7,l} is a bit-map indicator to indicate locations of the non-zero coefficients, and each element of i_{2,4,l}, i_{2,5,l}, and i_{1,7,l} indexed by l, i, f and r is associated with the priority value Pri(l, i, f, r). In various embodiments, the groups corresponds to one of: G0, G0 and G1, or G0, G1, and G2. In various embodiments, the group G2 includes └K^{NZ}/2┘ lowest priority elements of i_{1,7,l},

$$min ( {K}^{N Z} - v , ⌊ \frac{{K}^{N Z}}{2} ⌋ ) ,$$

lowest priority elements of i_{2,4,l} and

$$min ( {K}^{N Z} - v , ⌊ \frac{{K}^{N Z}}{2} ⌋ )$$

lowest priority elements of i_{2,5,l} (l=1, . . . , v), where: i_{2,4,l} and i_{2,5,l} are indicators to indicate amplitudes and phases of non-zero coefficients, i_{1,7,l} is a bit-map indicator to indicate locations of the non-zero coefficients, and each element of i_{2,4,l}, i_{2,5,l}, and i_{1,7,l} indexed by l, i, f and r is associated with the priority value Pri(l, i, f, r).

The UE then transmits the CSI Part 1 and the determined CSI Part 2 (1310). For example, in 1310, the UE transmits the CSI report including the CSI Part 1 and the CSI Part 2.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a transceiver configured to receive information about a channel state information (CSI) report associated with Nₜᵣₚ≥1 CSI reference signal (CSI-RS) resources, where the CSI report includes a CSI Part 1 and a CSI Part 2,
a processor operably coupled to the transceiver, the processor, based on the information, configured to:
determine the CSI Part 2 including groups G1 or G2, wherein an amplitude coefficient indicator and a phase coefficient indicator are included in G1 or G2 based on a priority value:
Pri(l, i, f, r)=2·Σₙ₌₁^{N}L_{ϕ(n)}·v·π(f)+2·v·Σₙ₌₁^{r-1}L_{ϕ(n)}+v·i+l,
where:
π(f) is a permutation function,
Lᵣ is a number of spatial-domain (SD) basis vectors associated with CSI-RS resource r,
ϕ(n) is a function to map an index n ∈{1, . . . , N} to a CSI-RS resource index r E {1, . . . , Nₜᵣₚ},
v is a number of layers,
l=1,2, . . . , v,
i=0,1, . . . ,2Lᵣ−1,
f=0,1, . . . , Mᵥ−1,
Mᵥ is a number of frequency-domain (FD) basis vectors, and
1≤N≤Nₜᵣₚ,
wherein the transceiver is further configured to transmit the CSI Part 1 and the determined CSI Part 2.

2. The UE of claim 1, wherein the permutation function π(f) corresponds to π(f)=min(2·n₃^{(f)},2(N₃−n₃^{(f)})−1), where n₃^{(f)} is a FD basis vector index, and N₃ is a number of precoding matrices.

3. The UE of claim 1, wherein the CSI Part 1 includes a channel quality indicator (CQI), a rank indicator (RI), and a total number of non-zero coefficients (NZC) K^{NZ} across all v layers and N CSI-RS resources.

4. The UE of claim 1, wherein:
the CSI Part 2 further includes a group G0, and
the group G0 includes:
an indicator of 11,1 indicating SD rotation factors (q_{1,r}, q_{2,r}) for each CSI-RS resource r,
an indicator of i_{1,2} indicating Lᵣ SD basis selection for each CSI-RS resource r, and
a strongest coefficient indicator of i_{1,8,l} across all N CSI-RS resources for each layer l=1, . . . , v.

5. The UE of claim 1, wherein the group G1 includes v2ΣᵣLᵣMᵥ−└K^{NZ}/2┘ highest priority elements of i_{1,7,l} ,
$$max ( 0 , ⌈ \frac{{K}^{N Z}}{2} ⌉ - υ ) ,$$
highest priority elements of i_{2,4,l}, and
$$max ( 0 , ⌈ \frac{{K}^{N Z}}{2} ⌉ - υ )$$
highest priority elements of i_{2,5,l} (l=1, . . . , v),
where:
i_{2,4,l} and i_{2,5,l} are indicators to indicate amplitudes and phases of non-zero coefficients,
i_{1,7,l} is a bit-map indicator to indicate locations of the non-zero coefficients, and
each element of i_{2,4,l}, i_{2,5,l}, and i_{1,7,l} indexed by l, i, f and r is associated with the priority value Pri(l, i, f, r).

6. The UE of claim 1, wherein the information includes information to include an indicator, in a group G0, to indicate a FD offset value for each of (N−1) CSI-RS resources.

7. The UE of claim 1, wherein the group G2 includes └K^{NZ}/2┘ lowest priority lowest priority elements of i_{2,4,l}, and elements of i_{1,7,l},
$$min ( {K}^{N Z} - v , ⌊ \frac{{K}^{N Z}}{2} ⌋ )$$
lowest priority elements of i_{2,5,l}, (l=1, . . . , v),
$$min ( {K}^{N Z} - v , ⌊ \frac{{K}^{N Z}}{2} ⌋ ) ,$$
where:
i_{2,4,l} and i_{2,5,l} are indicators to indicate amplitudes and phases of non-zero coefficients,
i_{1,7,l} is a bit-map indicator to indicate locations of the non-zero coefficients, and
each element of i_{2,4,l}, i_{2,5,l}, and i_{1,7,l} indexed by l, i, f and r is associated with the priority value Pri(l, i, f, r).

8. The UE of claim 1, wherein the groups corresponds to one of:
G0 and G1, or
G0, G1, and G2.

9. A base station (BS) comprising:
a transceiver configured to:
transmit information about a channel state information (CSI) report associated with Nₜᵣₚ≥1 CSI reference signal (CSI-RS) resources, where the CSI report includes a CSI Part 1 and a CSI Part 2; and
receive the CSI Part 1 and the CSI Part 2;
wherein the CSI Part 2 includes groups G1 or G2,
wherein an amplitude coefficient indicator and a phase coefficient indicator are included in G1 or G2 based on a priority value:
Pri(l, i, f, r)=2·Σₙ₌₁^{N}L_{ϕ(n)}·v·π(f)+2·v·Σₙ₌₁^{r-1}L_{ϕ(n)}+v·i+l,
where:
π(f) is a permutation function,
Lᵣ is a number of spatial-domain (SD) basis vectors associated with CSI-RS resource r,
ϕ(n) is a function to map an index n ∈{1, . . . , N} to a CSI-RS resource index r E {1, . . . , Nₜᵣₚ},
v is a number of layers,
l=1,2, . . . , v,
i=0,1, . . . ,2Lᵣ−1,
f=0,1, . . . , Mᵥ−1,
Mᵥ is a number of frequency-domain (FD) basis vectors, and
1≤N≤Nₜᵣₚ,

10. The BS of claim 9, wherein the permutation function (f) corresponds to π(f)=min(2·n₃^{(f)},2(N₃−n₃^{(f)})−1), where n₃^{(f)} is a FD basis vector index, and N₃ is a number of precoding matrices.

11. The BS of claim 9, wherein the CSI Part 1 includes a channel quality indicator (CQI), a rank indicator (RI), and a total number of non-zero coefficients (NZC) K^{NZ} across all v layers and N CSI-RS resources.

12. The BS of claim 9, wherein:
the CSI Part 2 further includes a group G0, and
the group G0 includes:
an indicator of i_{1,1} indicating SD rotation factors (q_{1,r}, q_{2,r}) for each CSI-RS resource r,
an indicator of i_{1,2} indicating Lᵣ SD basis selection for each CSI-RS resource r, and
a strongest coefficient indicator of i_{1,8,l} across all N CSI-RS resources for each layer l=1, . . . , v.

13. The BS of claim 9, wherein the group G1 includes v2ΣᵣLᵣMᵥ−└K^{NZ}/2┘ highest
$$max ( 0 , ⌈ \frac{{K}^{N Z}}{2} ⌉ - υ ) ,$$
priority elements of i_{1,7,l}, highest priority elements of i_{2,4,l}, and
$$max ( 0 , ⌈ \frac{{K}^{N Z}}{2} ⌉ - υ )$$
highest priority elements of i_{2,5,l} (l=1, . . . , v), where:
i_{2,4,l} and i_{2,5,l} are indicators to indicate amplitudes and phases of non-zero coefficients, i_{1,7,l} is a bit-map indicator to indicate locations of the non-zero coefficients, and each element of i_{2,4,l}, i_{2,5,l}, and i_{1,7,l} indexed by l, i, f and r is associated with the priority value Pri(l, i, f, r).

14. The BS of claim 9, wherein the information includes information to include an indicator, in a group G0, to indicate a FD offset value for each of (N−1) CSI-RS resources.

15. The BS of claim 9, wherein the group G2 includes └K^{NZ}/2┘ lowest priority elements of i_{1,7,l},
$$min ( {K}^{N Z} - v , ⌊ \frac{{K}^{N Z}}{2} ⌋ ) ,$$
lowest priority elements of i_{2,4,l} and
$$min ( {K}^{N Z} - v , ⌊ \frac{{K}^{N Z}}{2} ⌋ )$$
lowest priority elements of i_{2,5,l} (l=1, . . . , v),
where:
i_{2,4,l} and i_{2,5,l} are indicators to indicate amplitudes and phases of non-zero coefficients,
i_{1,7,l} is a bit-map indicator to indicate locations of the non-zero coefficients, and
each element of i_{2,4,l}, i_{2,5,l}, and i_{1,7,l} indexed by l, i, f and r is associated with the priority value Pri(l, i, f, r).

16. The BS of claim 9, wherein the groups corresponds to one of:
G0 and G1, or
G0, G1, and G2.

17. A method performed by a user equipment (UE), the method comprising:
receiving information about a channel state information (CSI) report associated with Nₜᵣₚ≥1 CSI reference signal (CSI-RS) resources, where the CSI report includes a CSI Part 1 and a CSI Part 2,
based on the information, determining the CSI Part 2 including groups G1 or G2, wherein an amplitude coefficient indicator and a phase coefficient indicator are included in G1 or G2 based on a priority value:
Pri(l, i, f, r)=2·Σₙ₌₁^{N}L_{ϕ(n)}·v·π(f)+2·v·Σₙ₌₁^{r-1}L_{ϕ(n)}+v·i+l,
where:
π(f) is a permutation function,
Lᵣ is a number of spatial-domain (SD) basis vectors associated with CSI-RS resource r,
ϕ(n) is a function to map an index n ∈{1, . . . , N} to a CSI-RS resource index r E {1, . . . , Nₜᵣₚ},
v is a number of layers,
l=1,2, . . . , v,
i=0,1, . . . ,2Lᵣ−1,
f=0,1, . . . , Mᵥ−1,
Mᵥ is a number of frequency-domain (FD) basis vectors, and
1≤N≤Nₜᵣₚ,

18. The method of claim 17, wherein the permutation function (f) corresponds to π(f)=min(2·n₃^{(f)},2(N₃−n₃^{(f)})−1), where N₃^{(f)} is a FD basis vector index, andN₃ is a number of precoding matrices.

19. The method of claim 17, wherein the CSI Part 1 includes a channel quality indicator (CQI), a rank indicator (RI), and a total number of non-zero coefficients (NZC) K^{NZ} across all v layers and N CSI-RS resources.

20. The method of claim 17, wherein:
the CSI Part 2 further includes a group G0, and
the group G0 includes:
an indicator of i_{1,1} indicating SD rotation factors (q_{1,r}, q_{2,r}) for each CSI-RS resource r,
an indicator of i_{1,2} indicating Lᵣ SD basis selection for each CSI-RS resource r, and
a strongest coefficient indicator of i_{1,8,l} across all N CSI-RS resources for each layer l=1, . . . , v.
